(19) United States
(12) Patent Application Publication
(10) Pub. No.: US 2025/0192842 A1
(43) Pub. Date: Jun. 12, 2025

(54) TECHNIQUES FOR SEPARATE CHANNEL STATE INFORMATION REPORTING CONFIGURATIONS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 18/842,320

(22) PCT Filed: Apr. 18, 2022
(86) PCT No.: PCT/CN2022/087328

§ 371 Date: Aug. 28, 2024

(51) Int. Cl. H04B 7/06; H04W 24/10; H04W 72/044; H04W 72/11

(52) U.S. Cl. CPC H04B 7/0626; H04W 24/10; H04W 72/046; H04W 72/11

(57) ABSTRACT

Methods, systems, and devices for wireless communications are described. A user equipment (UE) may receive, from a network entity, control signaling indicating a first channel state information (CSI) report setting configuration associated with measured channel characteristics of a first channel measurement resource (CMR) set and a second CSI report setting configuration associated with predicted channel characteristics for a second CMR set that is associated with the first CMR set. The UE may transmit a first CSI report that indicates one or more measured channel characteristics of the first CMR set based at on the first CSI report setting configuration and a second CSI report that indicates one or more predicted channel characteristics based on the second CSI report setting configuration.

### CROSS REFERENCE

The present application is a 371 national phase filing of International PCT Application No. PCT/CN2022/087328 by LI et al., entitled “TECHNIQUES FOR SEPARATE CHANNEL STATE INFORMATION REPORTING CONFIGURATIONS,” filed Apr. 18, 2022, which is assigned to the assignee hereof, and which is expressly incorporated by reference in its entirety herein.

### FIELD OF TECHNOLOGY

The following relates to wireless communications, including techniques for separate channel state information reporting configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for separate channel state information (CSI) reporting configurations. For example, the described techniques provide for configuring a user equipment (UE) with multiple CSI report settings, such as at least a first CSI report setting associated with measured channel characteristics and at least a second CSI report setting associated with predicted channel characteristics. The first CSI report setting may be associated with a first channel measurement resource (CMR) set, and the second CSI report setting may be associated with a second CMR set. In some examples, the first CMR set and the second CMR set may be associated. The UE may be configured to perform CSI reporting of measured and predicted channel characteristics in the time domain, spatial domain, frequency domain, or any combination thereof, in accordance with a corresponding CSI report setting.

A method for wireless communications at a UE is described. The method may include receiving, from a network entity, control signaling indicating a first CSI report setting configuration associated with measured channel characteristics of a first CMR set and a second CSI report setting configuration associated with predicted channel characteristics for a second CMR set that is associated with the first CMR set, transmitting a first CSI report that indicates one or more measured channel characteristics of the first CMR set based on the first CSI report setting configuration, and transmitting a second CSI report that indicates one or more predicted channel characteristics based on the second CSI report setting configuration.

An apparatus for wireless communications is described. The apparatus may include memory, a transceiver, and at least one processor of a UE, the at least one processor coupled with the memory and the transceiver. The at least one processor may be configured to cause the apparatus to receive, from a network entity via the transceiver, control signaling indicating a first CSI report setting configuration associated with measured channel characteristics of a first CMR set and a second CSI report setting configuration associated with predicted channel characteristics for a second CMR set that is associated with the first CMR set, transmit, via the transceiver, a first CSI report that indicates one or more measured channel characteristics of the first CMR set based on the first CSI report setting configuration, and transmit, via the transceiver, a second CSI report that indicates one or more predicted channel characteristics based on the second CSI report setting configuration.

Another apparatus for wireless communications at a UE is described. The apparatus may include means for receiving, from a network entity, control signaling indicating a first CSI report setting configuration associated with measured channel characteristics of a first CMR set and a second CSI report setting configuration associated with predicted channel characteristics for a second CMR set that is associated with the first CMR set, means for transmitting a first CSI report that indicates one or more measured channel characteristics of the first CMR set based on the first CSI report setting configuration, and means for transmitting a second CSI report that indicates one or more predicted channel characteristics based on the second CSI report setting configuration.

A non-transitory computer-readable medium storing code for wireless communications at a UE is described. The code may include instructions executable by a processor to receive, from a network entity, control signaling indicating a first CSI report setting configuration associated with measured channel characteristics of a first CMR set and a second CSI report setting configuration associated with predicted channel characteristics for a second CMR set that is associated with the first CMR set, transmit a first CSI report that indicates one or more measured channel characteristics of the first CMR set based on the first CSI report setting configuration, and transmit a second CSI report that indicates one or more predicted channel characteristics based on the second CSI report setting configuration.

In some examples of the method, apparatuses, and non-transitory computer-readable medium described herein, receiving the control signaling may include operations, features, means, or instructions for receiving the control signaling indicating a periodicity or semi-persistent scheduling associated with the first CMR set, where the second CMR set associated with the first CMR set corresponds to one or more resources occurring a defined time duration after a resource of the first CMR set indicated by the periodicity or the semi-persistent scheduling.

In some examples of the method, apparatuses, and non-transitory computer-readable medium described herein, receiving the control signaling may include operations, features, means, or instructions for receiving the control signaling indicating a first number of resources to report from the first CMR set in the first CSI report, a second number of resources to report from the second CMR set in the second CSI report, or both.

Some examples of the method, apparatuses, and non-transitory computer-readable medium described herein may further include operations, features, means, or instructions for measuring a set of reference signals over the first CMR set at a first time to obtain the one or more measured channel characteristics, where the first CMR set may be associated with the first CSI report setting configuration and determining a first set of predicted channel characteristics for the second CMR set for a second time which may be later than the first time, where the second CSI report includes the first set of predicted channel characteristics, and the second CMR set may be associated with the second CSI report setting configuration.

Some examples of the method, apparatuses, and non-transitory computer-readable medium described herein may further include operations, features, means, or instructions for determining a second set of predicted channel characteristics for a third CMR set for a third time which may be later than the first time and the second time, where the third CMR set may be associated with the second CMR set and the second CSI report setting configuration and transmitting a third CSI report indicating the second set of predicted channel characteristics based on the second CSI report setting configuration.

In some examples of the method, apparatuses, and non-transitory computer-readable medium described herein, receiving the control signaling may include operations, features, means, or instructions for receiving the control signaling indicating a first set of beams for reporting the measured channel characteristics associated with the first CMR set and the second CMR set, where the control signaling indicates to report the one or more predicted channel characteristics for a second set of beams associated with highest predicted channel characteristics of the second CMR set.

In some examples of the method, apparatuses, and non-transitory computer-readable medium described herein, receiving the control signaling may include operations, features, means, or instructions for receiving the control signaling indicating a first number of beams to report in the first CSI report, a second number of beams to report in the second CSI report, or both.

Some examples of the method, apparatuses, and non-transitory computer-readable medium described herein may further include operations, features, means, or instructions for measuring a set of reference signals over a first set of spatial beams of the first CMR set to obtain the one or more measured channel characteristics and determining the one or more predicted channel characteristics for a second set of spatial beams of the second CMR set, where the first CMR set and the second CMR set may be a same CMR set.

Some examples of the method, apparatuses, and non-transitory computer-readable medium described herein may further include operations, features, means, or instructions for receiving, from the network entity, an indication of the first set of spatial beams of the first CMR set, where the set of reference signals may be measured over the first set of spatial beams based on the indication.

Some examples of the method, apparatuses, and non-transitory computer-readable medium described herein may further include operations, features, means, or instructions for determining, by the UE, the first set of spatial beams, where the set of reference signals may be measured over the first set of spatial beams based on the determining.

In some examples of the method, apparatuses, and non-transitory computer-readable medium described herein, receiving the control signaling may include operations, features, means, or instructions for receiving the control signaling indicating a first radio frequency spectrum band associated with the first CMR set, where the second CMR set associated with the first CMR set corresponds to a second radio frequency spectrum band associated with the first radio frequency spectrum band.

Some examples of the method, apparatuses, and non-transitory computer-readable medium described herein may further include operations, features, means, or instructions for measuring a set of reference signals over a first radio frequency spectrum band including the first CMR set to obtain the one or more measured channel characteristics, where the first CMR set may be associated with the first CSI report setting configuration and determining the one or more predicted channel characteristics for a second radio frequency spectrum band including the second CMR set, where the second CMR set may be associated with the second CSI report setting configuration.

In some examples of the method, apparatuses, and non-transitory computer-readable medium described herein, the first radio frequency spectrum band and the second radio frequency spectrum band correspond to different bandwidth parts, different frequency ranges, different serving cells, or any combination thereof.

Some examples of the method, apparatuses, and non-transitory computer-readable medium described herein may further include operations, features, means, or instructions for transmitting, to the network entity, an indication of a UE capability to support multiple CSI report setting configurations, where the control signaling indicating the first CSI report setting configuration and the second CSI report setting configuration may be received in response to the indication of the UE capability.

In some examples of the method, apparatuses, and non-transitory computer-readable medium described herein, the indication of the UE capability includes a first number of supported configurations for the first CSI report setting configuration, a second number of supported configurations for the second CSI report setting configuration, a maximum number of supported configurations for both the first CSI report setting configuration and the second CSI report setting configuration, a number of processors supported for the first CSI report setting configuration or the second CSI report setting configuration, or both, or any combination thereof.

In some examples of the method, apparatuses, and non-transitory computer-readable medium described herein, transmitting the second CSI report may include operations, features, means, or instructions for transmitting the second CSI report on a same uplink channel as the first CSI report, where the first CSI report and the second CSI report may be multiplexed on the same uplink channel.

Some examples of the method, apparatuses, and non-transitory computer-readable medium described herein may further include operations, features, means, or instructions for determining a third CSI report associated with the first CSI report setting configuration may be scheduled to at least partially overlap on an uplink channel with a fourth CSI report associated with the second CSI report setting configuration, dropping the third CSI report based on predicted channel characteristics having a higher priority than measured channel characteristics, and transmitting the fourth CSI report on the uplink channel based on the second CSI report setting configuration.

Some examples of the method, apparatuses, and non-transitory computer-readable medium described herein may further include operations, features, means, or instructions for determining a third CSI report associated with the first CSI report setting configuration may be scheduled to at least partially overlap on an uplink channel with a fourth CSI report associated with the second CSI report setting configuration, dropping the fourth CSI report based on measured channel characteristics having a higher priority than predicted channel characteristics, and transmitting the third CSI report on the uplink channel based on the first CSI report setting configuration.

In some examples of the method, apparatuses, and non-transitory computer-readable medium described herein, the first CSI report includes a first number of measured channel characteristics that may be equal to a second number of predicted channel characteristics in the second CSI report.

A method for wireless communications at a network entity is described. The method may include transmitting control signaling indicating a first CSI report setting configuration associated with measured channel characteristics of a first CMR set and a second CSI report setting configuration associated with predicted channel characteristics for a second CMR set that is associated with the first CMR set, receiving a first CSI report that indicates one or more measured channel characteristics of the first CMR set based on the first CSI report setting configuration, and receiving a second CSI report that indicates one or more predicted channel characteristics of the second CMR set based on the second CSI report setting configuration.

An apparatus for wireless communications is described. The apparatus may include memory and at least one processor of a network entity, the at least one processor coupled with the memory. The at least one processor may be configured to cause the apparatus to transmit control signaling indicating a first CSI report setting configuration associated with measured channel characteristics of a first CMR set and a second CSI report setting configuration associated with predicted channel characteristics for a second CMR set that is associated with the first CMR set, receive a first CSI report that indicates one or more measured channel characteristics of the first CMR set based on the first CSI report setting configuration, and receive a second CSI report that indicates one or more predicted channel characteristics of the second CMR set based on the second CSI report setting configuration.

Another apparatus for wireless communications at a network entity is described. The apparatus may include means for transmitting control signaling indicating a first CSI report setting configuration associated with measured channel characteristics of a first CMR set and a second CSI report setting configuration associated with predicted channel characteristics for a second CMR set that is associated with the first CMR set, means for receiving a first CSI report that indicates one or more measured channel characteristics of the first CMR set based on the first CSI report setting configuration, and means for receiving a second CSI report that indicates one or more predicted channel characteristics of the second CMR set based on the second CSI report setting configuration.

A non-transitory computer-readable medium storing code for wireless communications at a network entity is described. The code may include instructions executable by a processor to transmit control signaling indicating a first CSI report setting configuration associated with measured channel characteristics of a first CMR set and a second CSI report setting configuration associated with predicted channel characteristics for a second CMR set that is associated with the first CMR set, receive a first CSI report that indicates one or more measured channel characteristics of the first CMR set based on the first CSI report setting configuration, and receive a second CSI report that indicates one or more predicted channel characteristics of the second CMR set based on the second CSI report setting configuration.

In some examples of the method, apparatuses, and non-transitory computer-readable medium described herein, transmitting the control signaling may include operations, features, means, or instructions for transmitting the control signaling indicating a periodicity or semi-persistent scheduling associated with the first CMR set, where the second CMR set associated with the first CMR set corresponds to one or more resources occurring a defined time duration after a resource of the first CMR set indicated by the periodicity or the semi-persistent scheduling.

In some examples of the method, apparatuses, and non-transitory computer-readable medium described herein, transmitting the control signaling may include operations, features, means, or instructions for transmitting the control signaling indicating a first number of resources to report from the first CMR set in the first CSI report, a second number of resources to report from the second CMR set in the second CSI report, or both.

In some examples of the method, apparatuses, and non-transitory computer-readable medium described herein, the receiving may include operations, features, means, or instructions for receiving the first CSI report indicating the one or more measured channel characteristics for the first CMR set at a first time, where the first CMR set may be associated with the first CSI report setting configuration and receiving the second CSI report indicating a first set of predicted channel characteristics for the second CMR set for a second time which may be later than the first time, where the second CMR set may be associated with the second CSI report setting configuration.

In some examples of the method, apparatuses, and non-transitory computer-readable medium described herein, transmitting the control signaling may include operations, features, means, or instructions for transmitting the control signaling indicating a first set of beams for reporting the measured channel characteristics associated with the first CMR set and the second CMR set, where the control signaling indicates to report the one or more predicted channel characteristics for a second set of beams associated with highest predicted channel characteristics of the second CMR set.

In some examples of the method, apparatuses, and non-transitory computer-readable medium described herein, the receiving may include operations, features, means, or instructions for receiving the first CSI report indicating the one or more measured channel characteristics for a first set of spatial beams of the first CMR and receiving the second CSI report indicating the one or more predicted channel characteristics for a second set of spatial beams of the second CMR set.

In some examples of the method, apparatuses, and non-transitory computer-readable medium described herein, transmitting the control signaling may include operations, features, means, or instructions for transmitting the control signaling indicating a first radio frequency spectrum band associated with the first CMR set, where the second CMR set associated with the first CMR set corresponds to a second radio frequency spectrum band associated with the first radio frequency spectrum band.

In some examples of the method, apparatuses, and non-transitory computer-readable medium described herein, the receiving may include operations, features, means, or instructions for receiving the first CSI report indicating the one or more measured channel characteristics for a first radio frequency spectrum band including the first CMR set, where the first CMR set may be associated with the first CSI report setting configuration and receiving the second CSI report indicating the one or more predicted channel characteristics for a second radio frequency spectrum band including the second CMR set, where the second CMR set may be associated with the second CSI report setting configuration.

Some examples of the method, apparatuses, and non-transitory computer-readable medium described herein may further include operations, features, means, or instructions for receiving an indication of a UE capability to support multiple CSI report setting configuration, where the control signaling indicating the first CSI report setting configuration and the second CSI report setting configuration may be transmitted in response to the indication of the UE capability.

### BRIEF DESCRIPTION OF THE DRAWINGS

FIG. 1 illustrates an example of a wireless communications system that supports techniques for separate channel state information (CSI) reporting configurations in accordance with one or more aspects of the present disclosure.

FIG. 2 illustrates an example of a wireless communications system that supports techniques for separate CSI reporting configurations in accordance with one or more aspects of the present disclosure.

FIG. 3 illustrates an example of a time domain CSI reporting configuration that supports techniques for separate CSI reporting configurations in accordance with one or more aspects of the present disclosure.

FIG. 4 illustrates an example of a spatial domain CSI reporting configuration that supports techniques for separate CSI reporting configurations in accordance with one or more aspects of the present disclosure.

FIG. 5 illustrates an example of a frequency domain CSI reporting configuration that supports techniques for separate CSI reporting configurations in accordance with one or more aspects of the present disclosure.

FIG. 6 illustrates an example of a process flow that supports techniques for separate CSI reporting configurations in accordance with one or more aspects of the present disclosure.

FIGS. 7 and 8 show block diagrams of devices that support techniques for separate CSI reporting configurations in accordance with one or more aspects of the present disclosure.

FIG. 9 shows a block diagram of a communications manager that supports techniques for separate CSI reporting configurations in accordance with one or more aspects of the present disclosure.

FIG. 10 shows a diagram of a system including a device that supports techniques for separate CSI reporting configurations in accordance with one or more aspects of the present disclosure.

FIGS. 11 and 12 show block diagrams of devices that support techniques for separate CSI reporting configurations in accordance with one or more aspects of the present disclosure.

FIG. 13 shows a block diagram of a communications manager that supports techniques for separate CSI reporting configurations in accordance with one or more aspects of the present disclosure.

FIG. 14 shows a diagram of a system including a device that supports techniques for separate CSI reporting configurations in accordance with one or more aspects of the present disclosure.

FIGS. 15 through 19 show flowcharts illustrating methods that support techniques for separate CSI reporting configurations in accordance with one or more aspects of the present disclosure.

### DETAILED DESCRIPTION

In some wireless communication systems, a user equipment (UE) may transmit a channel state information (CSI) report to indicate channel conditions to a network entity. In some cases, the UE may determine, and in some cases report, channel characteristic predictions between beam reports with lengthy periodicities (e.g., to improve beam management performance or reduce overhead). For example, the UE may report the channel characteristic predictions in a CSI report. For example, the UE may measure (e.g., based on a first CSI report configuration) channel characteristics for a first channel measurement resource (CMR) set and may predict channel characteristics (e.g., for the first CMR set or a different CMR set) based on the measurements. UEs in some systems may aggregate the measured and predicted channel characteristics into a CSI report according to a single CSI report setting. However, using a single CSI report setting for both measured and predicted channel characteristics may result in an increased overhead for every CSI report, as each CSI report may be configured to convey information for both measured and predicted channel characteristics, in some cases across multiple CMR sets.

In accordance with techniques described herein, a UE may be configured with multiple CSI reporting settings, such as a first CSI report setting for measured channel characteristics and a second CSI report setting for predicted channel characteristics. For example, the UE may be configured with a first CSI report setting for measured channel characteristics (e.g., based on actual measurements) of a first CMR set and a second CSI report setting for predicted channel characteristics of a second CMR set. The second CMR set may be associated with the first CMR set or may be the same as the first CMR set. For example, a network entity may transmit control signaling to configure the UE with periodic or semi-periodic CSI reports, and the control signaling may indicate the first and second CMR sets or indicate an association between the first and second CMR sets. The UE may be configured with reporting quantities for the first CSI report setting and the second CSI report setting, such as a number of beams or resources to measure for each CSI report setting. In some examples, the UE may be configured with multiple CSI report settings, such as multiple CSI report settings for measured channel characteristics or multiple CSI report settings for predicted channel characteristics, or both. The UE may transmit the measured CSI reports or predicted CSI reports, or both, based on associations between the first CSI report setting and the second CSI report setting and associations between the first CMR set and the second CMR set. The associations may be indicated via control signaling configuring the first CSI report setting or the second CSI report setting, or both.

The UE may be configured for measured and predicted CSI reporting in the time domain, frequency domain, or spatial domain, or any combination thereof. For example, the UE may report a first number of strongest measured beams at a first time in a first CSI report, and the UE may report a second number of strongest predicted beams at a second time in a second CSI report. In some cases, the UE may transmit an indication of a UE capability to support the multiple CSI report settings, such as indicating a number of supported settings for the first CSI report setting, the second CSI report setting, or in total. In some examples, the UE may be configured to report a first CSI report (e.g., indicating measured channel characteristics) and a second CSI report (e.g., indicating predicted channel characteristics) on a same or overlapping resource. The UE may be configured to perform multiplexing of the first CSI report and the second CSI report on a same slot, drop at least a portion of the first or second CSI reports based on priority, or apply an unequal priority protection to one or more overlapping CSI reports.

Aspects of the disclosure are initially described in the context of wireless communications systems. Aspects of the disclosure are further illustrated by and described with reference to apparatus diagrams, system diagrams, and flowcharts that relate to techniques for separate CSI reporting configurations.

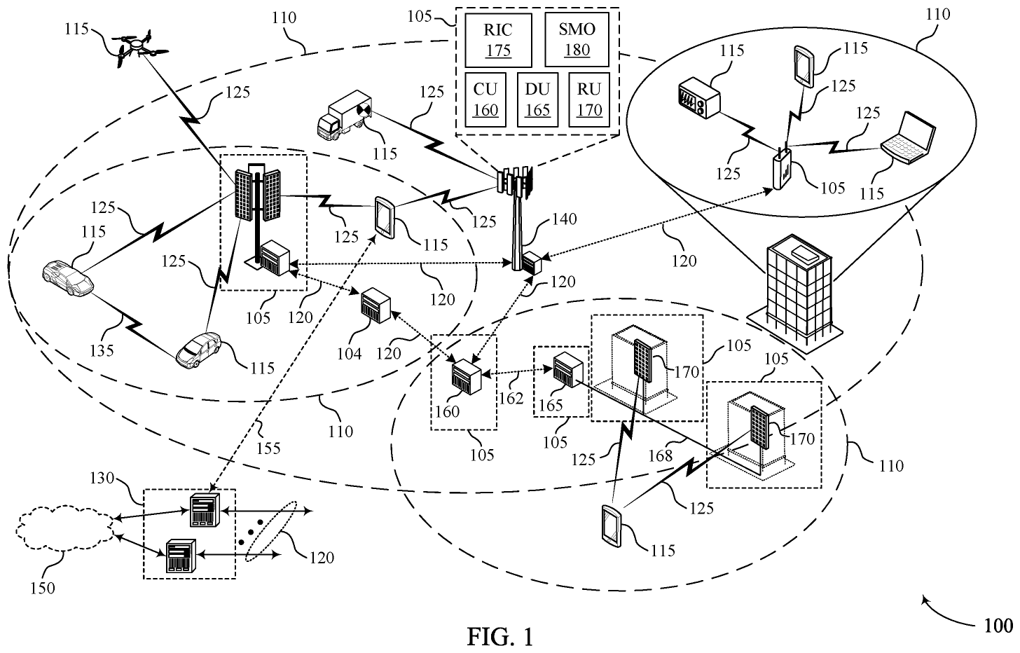

FIG. 1 illustrates an example of a wireless communications system 100 that supports techniques for separate CSI reporting configurations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for separate CSI reporting configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some wireless communications systems (e.g., wireless communications system 100) a UE 115 may provide measured and predicted channel characteristics to a network entity 105 via a CSI report. However, using a common CSI report setting for both measured and predicted channel characteristics may result in a large CSI report payload, as each CSI report may include fields for reporting measured channel characteristics, predicted channel characteristics, or both, in some cases across multiple CMR sets. The larger payload may increase overhead for every CSI report.

Wireless communications systems described herein, such as the wireless communications system 100, support techniques for CSI reporting using multiple CSI report settings or multiple CSI report configurations. For example, the wireless communications system 100 may support a first CSI report setting for reporting measured channel characteristics and a second CSI report setting for reporting predicted channel characteristics. A UE 115 may measure channel characteristics according to the first CSI reporting setting and may predict channel characteristics according to a second CSI reporting setting. As described herein, a UE 115 in wireless communications system 100 may support efficient techniques for reporting measured channel characteristics and predicted channel characteristics. In particular, the UE 115 may transmit multiple CSI reports to better indicate channel reliability to a network entity.

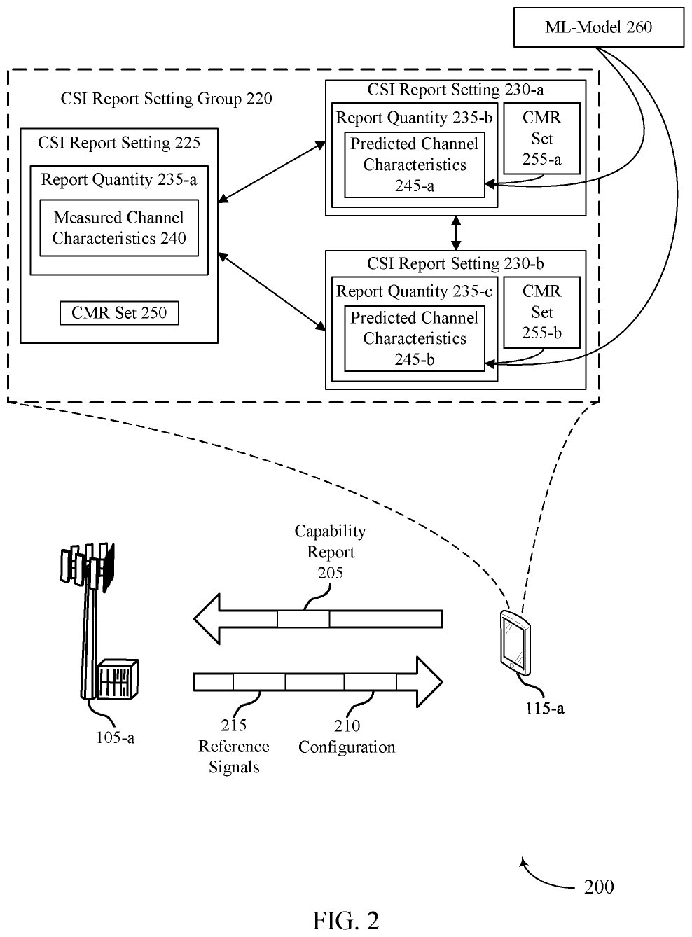

FIG. 2 illustrates an example of a wireless communications system 200 that supports techniques for separate CSI reporting configurations in accordance with one or more aspects of the present disclosure. The wireless communication system 200 may implement aspects of a wireless communication system 100 and may include a UE 115-a and a network entity 105-a, which may be examples of a UE 115 and a network entity 105 as described with reference to FIG. 1.

The UE 115-a and the network entity 105-a may implement multiple CSI report settings, such as separate CSI report settings for reporting measured channel characteristics and predicted channel characteristics. For example, the network entity 105-a may transmit control signaling indicating a configuration 210 for the multiple CSI report settings to the UE 115-a. The UE 115-a may be configured with the multiple CSI reporting settings and may transmit separate CSI reports for measured and predicted channel characteristics to the network entity 105-a based on separate CSI report settings for measured and predicted channel characteristics. By using the multiple CSI report settings, CSI reports for measured channel characteristics and CSI reports for predicted channel characteristics may each have lower overhead and smaller payloads than a CSI report which is used to report both predicted and measured channel characteristics, reducing overhead for the wireless communication system 200.

In some examples, the UE 115-a may indicate a capability to support being configured with multiple CSI report settings. For example, the UE 115-a may transmit a capability report 205 to the network entity 105-a, which may indicate whether the UE 115-a supports being configured with multiple CSI report settings. In some cases, the UE 115-a may support sub-configurations for a CSI report setting group, such as multiple CSI report settings, or sub-settings, for predicted characteristics. In some examples, the capability report 205 may indicate a maximum number of CSI report settings within a CSI report setting group. For example, the capability report 205 may indicate a maximum number of the first CSI report settings, a maximum number of the second CSI report settings, a total number of the first and second CSI report settings, or any combination thereof. In some examples, the capability report 205 may indicate a maximum number of CSI processing units (CPUs) that can be allocated for one or more of the CSI report setting group. For example, the UE 115-a may have a limited amount of machine learning resources for interference.

The network entity 105-b may transmit control signaling indicating a configuration 210 for the multiple CSI report settings to the UE 115-a. The configuration 210 may configure the UE 115-a with a CSI report setting group 220, which may include a first subset of CSI report settings (e.g., a CSI report setting 225) associated with measured channel characteristics of a first CMR set 250 and a second subset of CSI report settings (e.g., CSI report setting 230-a or CSI report setting 230-b) associated with predicted channel characteristics of a second CMR set 255. The second CMR set 255 may be associated with the first CMR set 250 or may be the same as the first CMR set 250 in some examples. For example, the UE 115-a may be jointly configured with a group of multiple CSI report settings (e.g., the CSI report setting group 220).

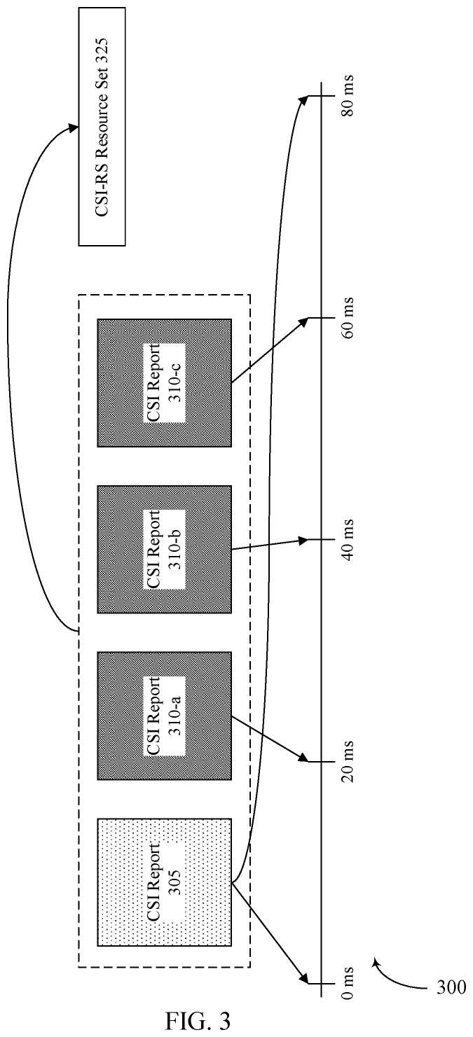

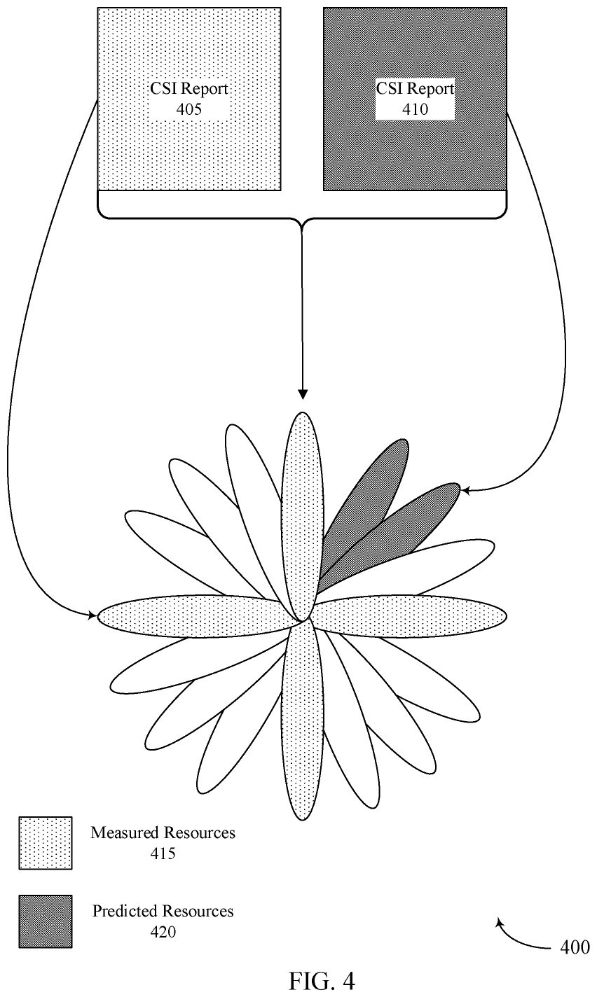

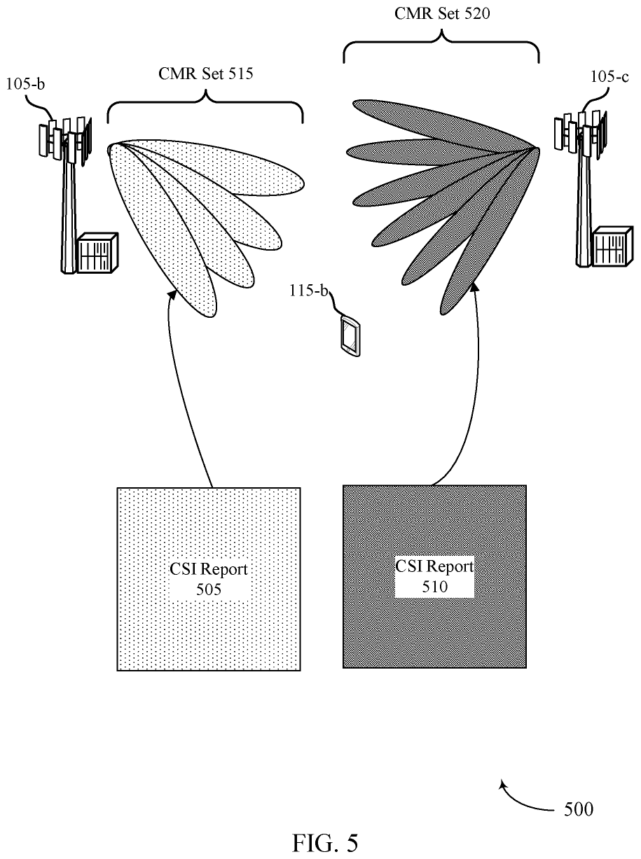

In some examples, the configuration 210 may configure the UE 115-a for periodic or semi-periodic CSI reporting in the time domain, frequency domain, or spatial domain. In some examples, the UE 115-a may receive reference signals 215 and generate measured channel characteristics, predicted channel characteristics, or both according to the configured domain. For example, the UE 115-a may transmit a CSI report configured according to the second CSI report setting to perform time domain channel characteristic prediction, spatial domain channel characteristic prediction, frequency domain channel characteristic prediction, or any combination thereof. An example of time domain beam prediction is described in more detail with reference to FIG. 3, an example of spatial domain beam prediction is described in more detail with reference to FIG. 4, and an example of frequency domain beam prediction is described in more detail with reference to FIG. 5.

For example, the UE 115-a may measure reference signals to generate a first CSI report in accordance with the first CSI report setting 225. The first CSI report setting 225 may include a report quantity 235-a. In some examples, the report quantity 235-a may correspond to a number of measurements to report in a first CSI report generated in accordance with the first CSI report setting 225. For example, the UE 115-a may determine measured channel characteristics 240, which may include N₁ measurements according to the report quantity 235-a, based on actual measurements of the first CMR set 250. The first CSI report may indicate measured channel characteristics for the first CMR set 250, such as Layer 1 RSRP, Layer 1 SINR, a rank indicator (RI), a precoding matrix indicator (PMI), layer indication (LI), a channel quality indicator (CQI), a packet data protocol (PDP), angle of arrival (AoA), angle of departure (AoD), an explicit channel, or any combination thereof.

Additionally, or alternatively, the UE 115-a may generate a second CSI report in accordance with the second CSI report setting 230, where the second CSI report indicates predicted channel characteristics of a second CMR set 255. The second CSI report setting 230 may include a report quantity 235 (e.g., report quantity 235-b or report quantity 235-c) for predicted channel characteristics 245 (e.g., predicted channel characteristics 245-a or predicted channel characteristics 245-b). The second CSI report setting 230, and any sub-settings of the CSI report setting 230, may be used to generate CSI reports which indicate predicted channel characteristics in the time, spatial, or frequency domain, such as Layer 1 RSRP, Layer 1 SINR, RI, PMI, LI, CQI, PDP, AoA, AoD, or explicit channel, or any combination thereof.

In some cases, the network entity 105-a may configure the UE 115-a to report measured channel characteristics associated with a first CMR set 250 and report predicted channel characteristics associated with a second CMR set 255. In some examples, the second CMR set 255 may be associated with the first CMR set. For example, the first CMR set 250 may correspond to a primary cell group of the network entity 105-a, and the second CMR set 255 may correspond to a secondary cell group of the network entity 105-a. In some cases, the configuration 210 may indicate the first CMR set 250 or the second CMR set 255, or both. Additionally, or alternatively, the configuration 210 may indicate an association between the first CMR set 250 and the second CMR set 255.

In some examples, the UE 115-a may determine predicted channel characteristics 245 for a second CMR set 255 based on a machine learning model 260. For example, the UE 115-a may determine the predicted channel characteristics 245 for a second CMR set 255 based on machine learning analysis or inferences of measured channel characteristics 240. In some cases, the predicted channel characteristics 245 may be determined based on an association between the first CSI report setting 225 and the second CSI report setting 230 or based on an association between the first CMR set 250 and the second CMR set 255.

In some cases, the UE 115-a may be configured with multiple sub-settings for a CSI report setting. For example, the UE 115-a may be configured with a first CSI report setting 230-a and a second CSI report setting 230-b, each of which may be associated with reporting predicted channel characteristics for a second CMR set 255-a and a second CMR set 255-b, respectively. In some examples, the second CMR set 255-a and the second CMR set 255-b may be the same or may be different. In some examples, the CSI report setting 230-a and the CSI report setting 230-b may have different reporting quantities 235. For example, the UE 115-a may report a first number of predicted channel characteristics (e.g., N₂ₐ predicted channel characteristics) for a CSI report in accordance with the CSI report setting 230-a, and the UE 115-a may report a second number of predicted channel characteristics (e.g., N_{2b} predicted channel characteristics) for a CSI report in accordance with the CSI report setting 230-b.

In some examples, the second CMR set 255 may be the same as the first CMR set 250. For example, the UE 115-a may report measured channel characteristics for a first CMR set in accordance with the first CSI report setting, and the UE 115-a may report predicted channel characteristics for the first CMR set at a later time in accordance with the second CSI report setting.

In some cases, the UE 115-a may separately transmit multiple CSI reports based on the CSI report settings. For example, the UE 115-a may transmit a first CSI report that indicates one or more measured channel characteristics 240 of the first CMR set 250 based on the first CSI report setting configuration 210. Additionally, or alternatively, the UE 115-a may transmit a second CSI report that indicates one or more predicted channel characteristics 245 of the second CMR set 255 based on the second CSI report setting configuration 210.

In some examples, a first CSI report for measured channel characteristics and a second CSI report for predicted channel characteristics may be multiplexed on a same slot. In some cases, the UE 115-a may expect that multiple CSI reports are multiplexed on a same channel (e.g., PUCCH or PUSCH) within a same slot. In some cases, the UE 115-a may perform a joint CSI processing unit (CPU) calculation across the multiple CSI reports. For example, a number of CPUs for channel characteristic measurement or prediction (e.g., via the machine learning model 260) may be jointly identified across the multiple CSI reports. In some examples, the UE 115-a may use a different number of CPUs for a CSI report indicating measured channel characteristics and a CSI report indicating predicted channel characteristics. Additionally, or alternatively, the UE 115-a may use a different number of CPUs for different sub-settings of a CSI report group configuration. In some cases, the UE 115-a may use a single CPU for a first CSI report of measured channel characteristics and a second CSI report of predicted channel characteristics. In some examples, a number of CPUs may be the same for a first case where two different CSI report according to the second CSI report setting 230 are generated (e.g., to predict two RSRPs) and a second case where three or more different CSI reports according to the second CSI report setting 230 are generated (e.g., to predict three or more later RSRPs). For example, the number of CPUs may be the same in a first case that includes two different 2nd CSI report settings (e.g., to predict L1-RSRPs that occur 20 ms and 40 ms later than a measured L1-RSRP) and in a second case that includes three different second CSI report settings (e.g., to predict L1-RSRPs that occur 20 ms, 40 ms, and 60 ms later than a measured L1-RSRP).

In some examples, multiple CSI reports may be multiplexed on a same uplink channel in a same slot. For example, a first CSI report carrying measured channel characteristics may be scheduled to at least partially overlap a second CSI report carrying predicted channel characteristics. In some examples, the UE 115-a may handle collisions between CSI reports via a set of priority rules. For, the UE 115-a may generate multiple CSI reports that exceed a payload size limitation for a single PUCCH or PUSCH transmission. The UE 115-a may drop at least portions of one or more CSI reports and may follow priority rules for determining which CSI reports should be dropped.

For example, when channel characteristics in the time domain are reported (as described further with reference to FIG. 3), a CSI report indicating measured channel characteristics (e.g., corresponding to the first CSI report setting 225) may have a higher priority than a CSI report indicating predicted channel characteristics (e.g., corresponding to the second CSI report setting 230). For multiple CSI reports carrying predicted channel characteristics, a first CSI report including predictions for a slot having a duration closer to the measurement slot (e.g., 20 ms after the measurement slot) may have higher priority than a second CSI report including predictions for a slot which is further away from the measurement slot (e.g., 40 ms after the measurement slot).

In some examples, when channel characteristics in the spatial domain (as described further with reference to FIG. 4) or the frequency domain (as described further with reference to FIG. 5) are reported, a CSI report indicating measured channel characteristics may have a lower priority than a CSI report indicating predicted channel characteristics. For example, predicted quantities in these domains may be considered more essential than measured quantities for the network entity 105-a to determine actual beams for scheduling PDSCH.

In some examples, the UE 115-a may apply unequal priority protection to one or more at least partially overlapping CSI reports. For example, the UE 115-a may associate different priorities with different parameters (e.g., modulation order or coding rate). For example, the UE 115-a may apply a lower coding rate to a lower priority CSI report, reducing the amount of overhead to transmit the lower priority CSI report but also reducing reliability. In some examples, the unequal priority protection schemes (e.g., code rates, modulation orders, etc.) may be configured within the wireless communications system, signaled by the network entity 105-a, indicated (e.g., recommended) by the UE 115-a, or any combination thereof.

In some examples, the control signaling indicating the configuration 210 may include one or more information elements to indicate the configuration 210. For example, the CSI report settings may be configured via one or more information elements, such as a CSI-ReportConfig-R19 information element. In some examples, the associations among different CSI report settings or among different CMR sets as described herein may be based on indicating in control signaling the associated CSI report setting identifiers in a certain CSI report setting or indicating in control signaling an associated CMR set identifier in a certain considered CSI report setting or a certain considered CMR set, or both.

FIG. 3 illustrates an example of a time domain CSI reporting configuration 300 that supports techniques for separate CSI reporting configurations in accordance with one or more aspects of the present disclosure. In some examples, the time domain CSI reporting configuration 300 may implement aspects of a wireless communication systems 100 or a wireless communications system 200. As described with reference to FIG. 2, a network entity 105 and a UE 115 may employ aspects of the time domain CSI reporting configuration 300 to communicate measured and predicted channel characteristics in separate CSI reports (e.g., a first CSI report 305 and a second CSI report 310) according to multiple CSI report settings (e.g., a first CSI report setting for measured channel characteristics and a second CSI report setting for predicted channel characteristics).

A UE 115 may be configured with multiple periodic or semi-periodic CSI report settings to report measured and predicted channel characteristics in the time domain. The UE 115 may, for example, transmit a first CSI report 305 to indicate measured channel characteristics, where the first CSI report 305 is generated in accordance with a first CSI report setting for measured channel characteristics. Additionally, or alternatively, the UE 115 may transmit a second CSI report 310 to indicate predicted channel characteristics, where the second CSI report 310 is generated in accordance with a second CSI report setting for predicted channel characteristics.

The UE 115 may measure reference signals on a first CMR set, such as a CSI-RS resource set 325, to obtain the measured channel characteristics for the first CSI report 305. The UE 115 may determine predicted channel characteristics for a second CSI report 310 associated with a second CMR set, where the second CMR set may be the same or different from the first CMR set. For example, a second CSI report 310 may indicate predicted channel characteristics for the CSI-RS resource set 325 (e.g., where the first CMR set and the second CMR set are identical) or for a different CMR set.

A first CSI report setting may correspond to measured channel characteristics of a first number of resources of a first CMR set associated with the first CSI-RS report setting. A first CSI report 305 may indicate measured channel characteristics for the first number of strongest resources of the CSI-RS resource set 325. For example, the first CSI report 305 may indicate an N₁ strongest resources, such as SSB or CSI-RS resources, of the first CMR set associated with the first CSI-RS report setting. The number of strongest resources to be reported in the first CSI report 305 may be indicated or configured by a first CSI report setting associated with the first CMR set and the first CSI report 305. In some examples, the first CSI report 305 may indicate a measured channel characteristic such as a Layer 1 RSRP or Layer 1 SINR, or any other channel characteristic described herein which may be indicated via a CSI report for measured channel characteristics. In some examples, a first periodic or semi-persistent CSI report setting of the first subset of CSI report settings may include measured L1-RSRP/L1-SINR of the N₁ strongest CSI-RS/SSB resources of a first CMR set associated with the first CSI report setting.

In an example, the UE 115 may be configured to report a first measurement at a first time (e.g., 0 ms) and periodically or semi-persistently report subsequent measurements (e.g., every 80 ms after the initial measurement). The UE 115 may measure the CSI-RS resource set 325 to determine a number (e.g., N₁) of strongest resources in the CSI-RS resource set 325. For example, the UE 115 may generate a first CSI report 305 that includes an indication of measured power (e.g., L1-RSRP or L1-SINR) for the N₁ strongest resources of the CSI-RS resource set 325. For example, the CSI-RS resource set 325 may include 16 CSI-RS resources, and the UE 115 may report the four strongest resources from the 16 CSI-RS resources. In some cases, the CSI-RS resource set 325 may be associated with, or configured with, the first CSI report setting for measured channel characteristics. In some examples, the second CSI report 310 may indicate a predicted channel characteristic such as a Layer 1 RSRP or Layer 1 SINR, or any other channel characteristic described herein which may be indicated via a CSI report for predicted channel characteristics.

A second CSI report setting may correspond to predicted channel characteristics of a second number of resources of a second CMR set associated with the second CSI-RS report setting. For time domain channel characteristic CSI reporting, a second CSI report 310 may indicate predicted channel characteristics corresponding to a time instance with a duration after a measurement time for determining measured channel characteristics for the first CSI report setting. For example, a second CSI report 310 may indicate a second number, N₂, of predicted strongest resources of the CSI-RS resource set 325, at a time after the initial measurement for the first CSI report 305. For example, a second CSI-RS report 310-a may indicate a predicted N₂ₐ strongest resources of the second CMR set associated with the second CSI-RS report setting at a second time, such as indicating a predicted four strongest resources of the second CMR set (e.g., the CSI-RS resource set 325) at 20 milliseconds after a measurement time for the first CSI report 305. In some examples a second periodic or semi-persistent CSI report setting of the second subset of CSI report settings may include machine learning predicted L1-RSRP/L1-SINR of the N₂ strongest CSI-RS/SSB resources of a second CMR set associated with the second CSI report setting, regarding a time instance with a duration (in terms of, e.g., one or more milliseconds, subframes, frames, slots, symbols, etc.) after the measurement slot or symbol for determining the corresponding L1-RSRP/L1-SINR for the first CSI report setting. In some examples, the UE 115 may expect that the first and second CMR sets are identical. In some cases, the second subset of CSI report settings may include multiple second periodic or semi-persistent CSI report settings, where the value of N₂ or the duration associated with different such second P/SP CSI report settings may be different.

In some examples, the UE 115 may be configured with multiple CSI report settings for predicted or measured channel characteristics. For example, the UE 115 may be configured with a second CSI report setting for predicted channel characteristics, where the UE 115 may report a different number of predicted channel characteristics or predicted channel characteristics for a different time, or both. For example, the UE 115 may transmit a second CSI report 310-b indicating a predicted N_{2b} strongest resources of the CSI-RS resource set 325 at a second time, such as 40 milliseconds after the measurement time for the first CSI report 305, based on the second CSI report setting for predicted channel characteristics. Similarly, a second CSI report 310-c may indicate a predicted N_{2c} strongest resources of the CSI-RS resource set 325 at a third time, such as 60 milliseconds after the measurement time for the first CSI report 305. In some examples, N₁ and N₂ values may be the same or different. For example, a first CSI report 305 and a second CSI report 310 may indicate equal or different numbers of measured and predicted channel characteristics.

The duration of time or gap between the measurement time and a predicted channel characteristic may be configurable. For example, a second CSI report 310 indicating a predicted channel characteristic may correspond to a number of symbols, subframes, slots, frames, or milliseconds after the measurement time for the first CSI report 305. In some examples, different second CSI report settings for predicted channel characteristics may have different durations of times or gaps, which may be configured or indicated by the second CSI report setting.

FIG. 4 illustrates an example of a spatial domain CSI reporting configuration 400 that supports techniques for separate CSI reporting configurations in accordance with one or more aspects of the present disclosure. In some examples, the spatial domain CSI reporting configuration 400 may implement aspects of wireless communication systems 100 or 200. The spatial domain CSI reporting configuration 400 may be implemented by a network entity 105 and a UE 115, which may be examples of a network entity 105 and a UE 115, as described with reference to FIGS. 1 and 2. The network entity 105 and the UE 115 may employ aspects of the spatial domain CSI reporting configuration 400 to communicate measured and predicted channel characteristics in separate CSI reports (e.g., a first CSI report 405 and a second CSI report 410) according to multiple CSI report settings (e.g., a first CSI report setting for measured channel characteristics and a second CSI report setting for predicted channel characteristics).

A UE 115 may be configured with multiple periodic or semi-persistently scheduled CSI report settings to report measured and predicted channel characteristics in the spatial domain. The UE may, for example, transmit a first CSI report 405 to indicate measured channel characteristics for a first CMR set, where the first CSI report 405 is generated in accordance with a first CSI report setting for measured channel characteristics of a first CMR set. Additionally, or alternatively, the UE 115 may transmit a second CSI report 410 to indicate predicted channel characteristics for a second CMR set, where the second CSI report 410 is generated in accordance with a second CSI report setting for predicted channel characteristics.

In some examples, the first CMR set and the second CMR set may be associated. For example, the first CMR set and the second CMR set may be the same. In some other examples, the second CMR set may be associated with the first CMR set, and the association may be indicated via control signaling configuring the first CSI report setting and the second CSI report setting.

The UE 115 may receive control signaling indicating multiple CSI report settings from the network entity 105, including least the first CSI report setting and the second CSI report setting. In some examples, the first CSI report setting may configure the UE to report measured channel characteristics for certain resources or certain beams of a first CMR set (e.g., measured L1-RSRP/L1-SINR of N₁ CSI-RS/SSB resources of the first CMR set associated with the first CSI report setting). In some examples, the first CSI report setting may indicate a number or quantity of measurements for the UE 115 to report in the first CSI report 405. For example, the UE 115 may report measurements of N₁ resources of the first CMR set, such as measured resources 415.

In some cases, the network entity 105 may indicate which resources the UE 115 is to measure for the first CSI report 405. For example, the network entity 105 may indicate certain resources for the UE 115 to measure in the first CSI report setting, and the UE 115 may report measured channel characteristics for the indicated resources in the CSI report 405. In some examples, the UE 115 may sequentially report the measured channel characteristics based on an ascending or descending order of resource identifiers of the indicated resources. For example, the UE 115 may determine the N₁ CSI-RS/SSB resources and reports the determined N₁ CSI-RS/SSB resources in the first periodic or semi-persistent CSI report. Then the UE 115 may sequentially report the L1-RSRPs/L1-SINRs based on the ascending or descending order of the determined CSI-RS/SSB resource identifiers (IDs). Additionally, or alternatively, the UE 115 may select the resources to measure for the first CSI report. For example, the UE 115 may identify the resources to measure for the first CSI report instead of being indicated the resources by the network entity 105. In some cases, the N₁ resources may not be the strongest resources in the CMR set or correspond to the strongest measured channel characteristics.

For example, the UE 115 may transmit a first CSI report 405 indicating measurements for the measured resources 415 based on the first CSI report setting. The measured resources 415 may be indicated by the network entity or determined by the UE 115. In an example, the UE 115 may report four measured channel characteristics, corresponding to beams with indexes 0, 4, 8, and 12 out of 16 beams from the network entity 105. The first CSI report 405 may indicate, for example, measured channel characteristics such as a measured Layer 1 RSRP or Layer 1 SINR of the measured resources 415 (e.g., the first CSI report 405 indicates N₁=4 measured RSRPs which may or might not be the strongest RSRPs).

In some cases, the second CSI report setting may configure the UE 115 to transmit the second CSI report 410 indicating predicted channel characteristics for a second CMR set associated with the second CSI report setting. For example, the UE 115 may transmit a second CSI report 410 indicating predicted channel characteristics for resources of the second CMR set associated with the second CSI report setting. For example, the UE 115 may transmit channel characteristics for predicted resources 420, which may correspond to the strongest resources of the second CMR set. In some examples, the UE 115 may be configured to report channel characteristics for a certain number or quantity of the predicted resources 420, such as N₂ resources. The second CSI report 410 may indicate, for example, N₂ resources with a predicted highest Layer 1 RSRP or Layer 1 SINR of the second CMR set (e.g., the second CSI report 410 indicates N₂=2 predicted strongest RSRPs). As described herein, the CMR set associated with the second CSI report setting may be the same CMR set of the first CSI report setting. For example, the first CMR set and the second CMR set maybe the same, or the first CMR set and the second CMR set may be different. In an example, a second periodic or semi-persistent CSI report setting of a second subset of CSI report settings, may include machine-learning predicted L1-RSRP/L1-SINR of the N₂ strongest CSI-RS/SSB resources of the second CMR set associated with the second CSI report setting. In some examples, the second CMR set associated with the second CSI report setting may be the same CMR set as that of the first CSI report setting.

In some cases, values of N₁ and N₂ may be configured by the respective CSI report settings. For example, the number of measured resources (e.g., N₁) indicated by a first CSI report 405 may be configured by the first CSI report setting, and the number of predicted strongest resources (e.g., N₂) indicated by a second CSI report 410 may be configured by the second CSI report setting. In some cases, the configuration may support values of N₁ and N₂ that are equal, or values of N₁ and N₂ that are not equal.

In some examples, reporting both the measured and predicted channel characteristics may enable the network entity 105 to make a better decision on the final beams to be used for communications with the UE 115. For example, the network entity 105 may measure one or more sounding reference signals (SRS) and may jointly use the reported measurements and predictions together with the SRS measurements to decide a beam to be used for scheduling PDSCH.

FIG. 5 illustrates an example of a frequency domain CSI reporting configuration 500 that supports techniques for separate CSI reporting configurations in accordance with one or more aspects of the present disclosure. In some examples, the frequency domain CSI reporting configuration 500 may implement aspects of wireless communication systems 100 or 200. The frequency domain CSI reporting configuration 500 may be implemented by one or more network entities 105 and a UE 115. For example, the frequency domain CSI reporting configuration may be implemented by a UE 115-b, a network entity 105-b, and a network entity 105-c, which may be respective examples of a UE 115 and network entities 105 as described with reference to FIGS. 1 and 2. The network entity 105-b, the network entity 105-c, and the UE 115-b may employ aspects of the frequency domain CSI reporting configuration 500 to communicate measured and predicted channel characteristics in separate CSI reports (e.g., a first CSI report 505 and a second CSI report 510) according to multiple CSI report settings (e.g., a first CSI report setting for measured channel characteristics and a second CSI report setting for predicted channel characteristics).

The UE 115-b may be configured with multiple periodic or semi-persistently scheduled CSI report settings to report measured and predicted channel characteristics in the frequency domain. The UE 115-b may, for example, transmit a first CSI report 505 to indicate measured channel characteristics for a first CMR set 515, where the first CSI report 505 is generated in accordance with a first CSI report setting for measured channel characteristics of the first CMR set 515. Additionally, or alternatively, the UE 115 may transmit a second CSI report 510 to indicate predicted channel characteristics for a second CMR set 520, where the second CSI report 510 is generated in accordance with a second CSI report setting for predicted channel characteristics.

For example, the UE 115-b may receive control signaling configuring the first CSI report setting associated with the first CMR set 515. The first CSI report setting may be defined in, for example, a first radio frequency spectrum band, a first bandwidth part, or a first serving cell. In some examples, the first radio frequency spectrum band may correspond to a first frequency range, such as Frequency Range 1 (FR1). The UE 115-b may generate the first CSI report 505 to indicate measured channel characteristics of a first number of resources of the first CMR set 515 associated with the first CSI report setting. The UE 115-b may, for example, report a first number or quantity of measured channel characteristics (e.g., N₁ measured channel characteristics) for resources in the first CMR set 515. For example, the UE 115-b may indicate a PDP or AoA for N₁ resources in the first CMR set 515. In an example, a first periodic or semi-persistent CSI report setting defined for a first bandwidth part (BWP), serving cell (ServCell) (e.g., in FR1), or the like, of the first subset of CSI report settings may include measured channel characteristics of N₁ CSI-RS/SSB resources of the CMR set (defined within the 1st BWP or ServCell) associated with the first CSI report setting.

The UE 115-b may receive control signaling configuring the second CSI report setting associated with the second CMR set 520. The second CSI report setting may be defined in, for example, a second radio frequency spectrum band, a second bandwidth part, or a second serving cell. In some examples, the second radio frequency spectrum band may correspond to a second frequency range, such as Frequency Range 2 (FR2). The UE 115-b may generate the second CSI report 510 to indicate predicted channel characteristics of a second number of resources of the second CMR set 520 associated with the second CSI report setting. The UE 115-b may, for example, report a second number or quantity of measured channel characteristics (e.g., N₂ measured channel characteristics) for resources in the second CMR set 520. For example, the UE 115-b may indicate, for example, the N₂ strongest RSRPs for resources of the second CMR set 520. The predicted channel characteristics may, in some cases, be determined based on a machine learning model, such as by inputting the measured channel characteristics of the first CMR set 515 into the machine learning model. In some examples, a second P/SP CSI report setting defined for a second BWP, a second ServCell (e.g., in FR2), or the like, of the second subset of CSI report settings may include machine learning predicted channel characteristics of N₂ CSI-RS/SSB resources of the CMR set (defined within the second BWP or the ServCell) associated with the second CSI report setting.

In some cases, values of N₁ and N₂ may be configured by the respective CSI report settings. For example, the number of measured resources (e.g., N₁) indicated by a first CSI report 505 may be configured by the first CSI report setting, and the number of predicted strongest resources (e.g., N₂) indicated by a second CSI report 510 may be configured by the second CSI report setting. In some cases, the configuration may support values of N₁ and N₂ that are equal, or values of N₁ and N₂ that are not equal.

In some examples, reporting both the measured channel characteristics over the first radio frequency spectrum band and predicted channel characteristics over the second radio frequency spectrum band may enable the primary serving cell (e.g., the network entity 105-b) to select high quality beams for communications with the UE 115-b. For example, the primary service cell may measure one or more SRS and may jointly use the reported measurements and predictions together with the SRS measurements to select beam to be used for scheduling PDSCH.

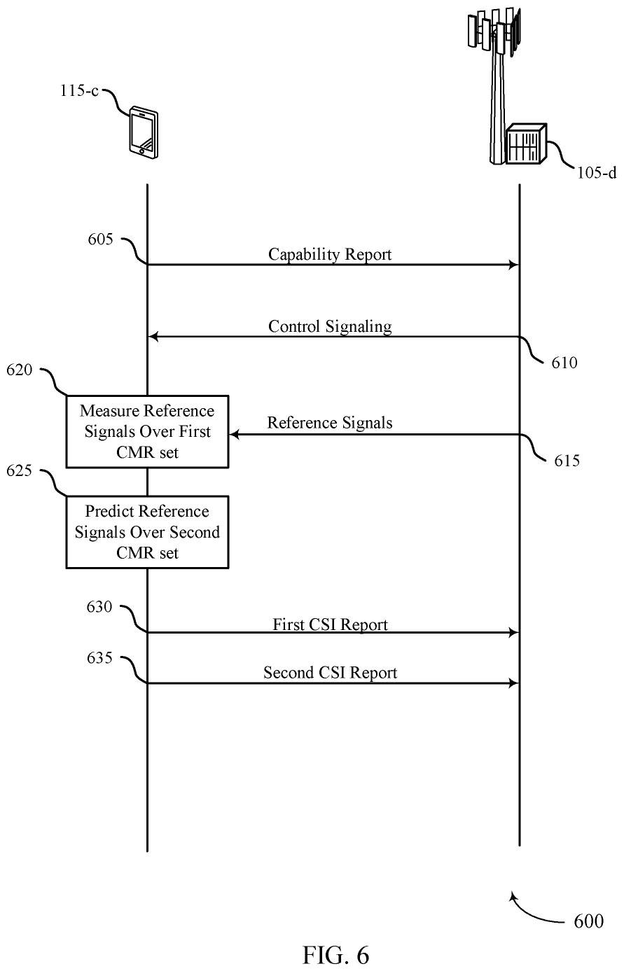

FIG. 6 illustrates an example of a process flow 600 that supports techniques for separate CSI reporting configurations in accordance with one or more aspects of the present disclosure. The process flow 600 may be implemented by a UE 115-c or a network entity 105-d, or both, which may be respective examples of a UE 115 and a network entity 105 as described with reference to FIGS. 1 and 2. In some examples, some signaling or procedures of the process flow 600 may occur in different orders than shown. Additionally, or alternatively, some additional procedures or signaling may occur, or some signaling or procedures shown may not occur.

In some examples, at 605, the UE 115-c may transmit (e.g., via a transceiver of the UE 115-c), to the network entity 105-d, an indication of a UE capability to support multiple CSI report setting configurations. For example, the UE 115-c may indicate a capability to support at least a first CSI report setting for reporting measured channel characteristics and a second CSI report setting for reporting predicted channel characteristics. In some examples, the UE 115-c may indicate a number (e.g., a maximum number) of CSI report settings within a CSI report setting group, including any one or more of a first number (e.g., a maximum number) of supported configurations for the first CSI report setting configuration, a second number (e.g., a maximum number) of supported configurations for the second CSI report setting configuration, a total number (e.g., a maximum number) of supported configurations for both the first CSI report setting configuration and the second CSI report setting configuration, or any combination thereof. In some examples, the UE 115-c may indicate a number (e.g., a maximum number) of CSI processing units (CSIs) supported for one or more CSI report setting groups. For example, a UE may have a defined amount of machine learning resource for prediction (e.g., for inference). In some cases, instead of reporting the numbers above as part of a UE capability, the numbers may be specified or predefined.

At 610, the network entity 105-d may transmit, and the UE 115-c may receive (e.g., via the transceiver of the UE 115-c), control signaling indicating a first CSI report setting configuration associated with measured channel characteristics of a first CMR set and a second CSI report setting configuration associated with predicted channel characteristics for a second CMR set that is associated with the first CMR set. For example, the UE 115-c may be configured with the first CSI report setting for measured channel characteristics and the second CSI report setting for predicted channel characteristics. In some examples, the control signaling may configure multiple CSI report settings for measured channel characteristics or multiple CSI report settings for predicted channel characteristics, or multiples of each. In some examples, the first CMR set and the second CMR set may be the same (e.g., identical), or the first CMR set and the second CMR set may be different. In some cases, the UE 115-c may receive the control signaling configuring the first CSI report setting configuration and the second CSI report setting configuration based on the UE capability.

The UE 115-c may be configured to transmit CSI reports for measured or predicted channel characteristics in the time domain, the spatial domain, or the frequency domain, or any combination thereof. For example, the UE 115-c may receive the control signaling indicating a periodicity or semi-persistent scheduling associated with the first CMR set. The second CMR set may be associated with the first CMR set based on corresponding to one or more resources occurring a defined time duration after a resource of the first CMR set indicated by the periodicity or the semi-persistent scheduling. As an example, the UE 115-c may perform a measured on resources of the first CMR set at a first time to obtain measured channel characteristics. The UE 115-c may predict channel characteristics for resources of the second CMR set at a second time (e.g., a number of symbols, slots, milliseconds, etc., after the first time) to obtain predicted channel characteristics.

In another example, the UE 115-c may be configured to perform CSI reporting of measured and predicted channel characteristics in the spatial domain. The UE 115-c may receive (e.g., via the transceiver of the UE 115-c) the control signaling indicating a first set of beams for reporting the measured channel characteristics associated with the first CMR set and the second CMR set. The control signaling may indicate to report the one or more predicted channel characteristics for a second set of beams associated with highest predicted channel characteristics of the second CMR set. In some examples, the control signaling may indicate which beams the UE 115-c is to measure of the first CMR set. For example, the network entity 105-d may configure the UE 115-c to report measurements for select beams from the first CMR set, even if those beams do not correspond to a strongest or highest channel measurement. In some other examples, the UE 115-c may select which beams to report. In some examples, the UE 115-c may report resources (e.g., beams) from the second CMR set with the highest or strongest channel characteristics, such as resources with a predicted highest RSRP or highest SINR.

In some examples, the UE 115-c may be configured to perform CSI reporting of measured and predicted channel characteristics in the frequency domain. For example, the UE 115-c may receive the control signaling indicating a first radio frequency spectrum band associated with the first CMR set. The second CMR set associated with the first CMR set may correspond to a second radio frequency spectrum band associated with the first radio frequency spectrum band. For example, the first CMR set may correspond to a first bandwidth part, first serving cell, or first frequency range, and the second CMR set may correspond to a second bandwidth part, second serving cell, or second frequency range.

In some examples, the control signaling may indicate a number or quantity of channel characteristics for the UE 115-c to report. For example, the first CSI report setting may configure the UE 115-c to report N₁ measured channel characteristics for the first CMR set. The second CSI report setting may configure the UE 115-c to report N₂ predicted channel characteristics for the second CMR set. If the UE 115-c is configured with multiple CSI report settings, each CSI report setting may have a corresponding number of reported resources. For example, the UE 115-c may report N₂ₐ predicted channel characteristics in accordance with a first CSI report setting for predicted channel characteristics, and the UE 115-c may report N_{2b} predicted channel characteristics in accordance with a second CSI report setting for predicted channel characteristics. The number of measurements or predictions may be the same or may be different. For example, N₁ may be equal to or different from N₂.

At 615, the network entity 105-d may transmit a set of reference signals to the UE 115-c over the first CMR set. The UE 115-c may measure the set of reference signals over the first CMR at 620 to obtain the measured channel characteristics. In some examples, the UE 115-c may determine the predicted channel characteristics at 625, such as based on the measured channel characteristics and a machine learning model. For example, the UE 115-c may input the measured channel characteristics into the machine learning model and obtain the predicted channel characteristics based on the associations between the first CMR set and the second CMR set. In some cases, such as if the UE 115-c is configured with multiple CSI report settings for predicted channel characteristics, the UE 115-c may determine predicted channel characteristics for another CMR set.

At 630, the UE 115-c may transmit (e.g., via the transceiver of the UE 115-c), and the network entity 105-d may receive, a first CSI report that indicates one or more measured channel characteristics of the first CMR set based on the first CSI report setting configuration. At 635, the UE 115-c may transmit (e.g., via the transceiver of the UE 115-c), and the network entity 105-d may receive, a second CSI report that indicates one or more predicted channel characteristics based on the second CSI report setting configuration.

In some examples, the first CSI report and the second CSI report may be multiplexed or scheduled on a same slot. If the first CSI report and the second CSI report exceed a payload size of an uplink transmission, the UE 115-c may drop at least a portion of one of the CSI reports, which may be based on priority. For example, if a time domain measured CSI report at least partially overlaps a time domain predicted CSI report, the UE 115-c may drop at least portions of the predicted CSI reports. If two time domain predicted CSI reports at least partially overlap, the UE 115-c may drop a predicted CSI report which is for a later time (e.g., further away from a measurement time for a measured CSI report). For spatial domain and frequency domain CSI report, the UE 115-c prioritize predicted CSI reports, and the UE 115-c may drop at least portions of CSI reports indicating measured channel characteristics if a predicted CSI report at least partially overlaps a measured CSI report.

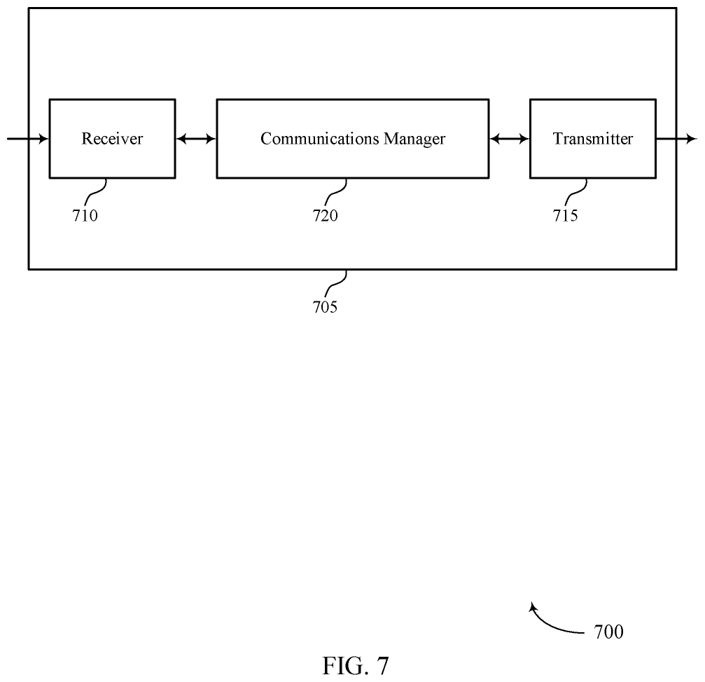

FIG. 7 shows a block diagram 700 of a device 705 that supports techniques for separate CSI reporting configurations in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for separate CSI reporting configurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for separate CSI reporting configurations). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for separate CSI reporting configurations as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The communications manager 720 may be configured as or otherwise support a means for transmitting a first CSI report that indicates one or more measured channel characteristics of the first CMR set based on the first CSI report setting configuration. The communications manager 720 may be configured as or otherwise support a means for transmitting a second CSI report that indicates one or more predicted channel characteristics based on the second CSI report setting configuration.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for lower overhead while supporting CSI reports for both measured and predicted channel characteristics. For example, by using separate CSI report settings for measured and predicted channel characteristics, a CSI report may include fields related to either measured channel characteristics or predicted channel characteristics instead of including unused fields.

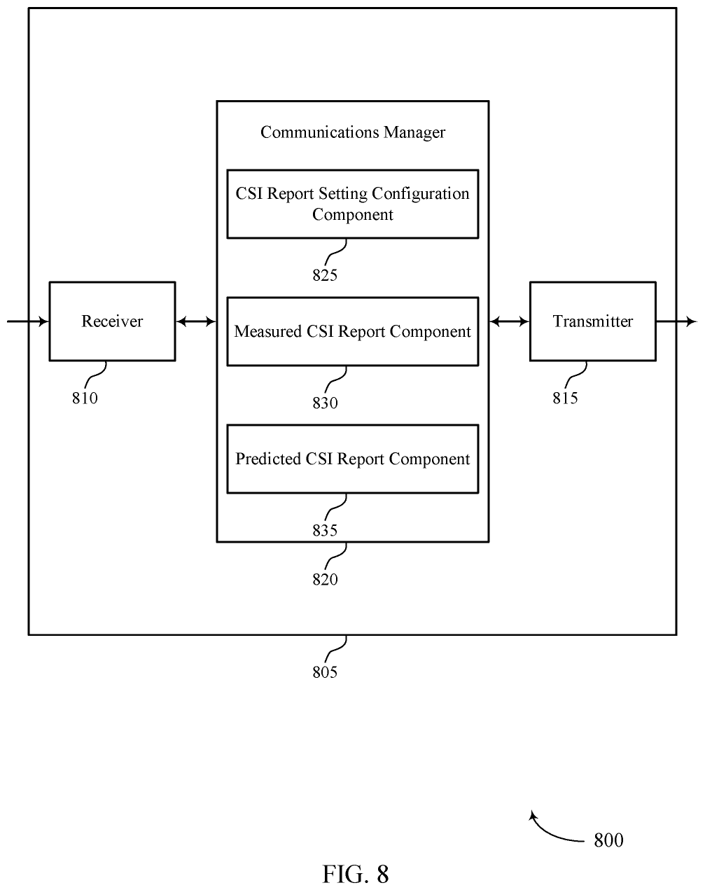

FIG. 8 shows a block diagram 800 of a device 805 that supports techniques for separate CSI reporting configurations in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for separate CSI reporting configurations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for separate CSI reporting configurations). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for separate CSI reporting configurations as described herein. For example, the communications manager 820 may include a CSI report setting configuration component 825, a measured CSI report component 830, a predicted CSI report component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The CSI report setting configuration component 825 may be configured as or otherwise support a means for receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The measured CSI report component 830 may be configured as or otherwise support a means for transmitting a first CSI report that indicates one or more measured channel characteristics of the first CMR set based on the first CSI report setting configuration. The predicted CSI report component 835 may be configured as or otherwise support a means for transmitting a second CSI report that indicates one or more predicted channel characteristics based on the second CSI report setting configuration.

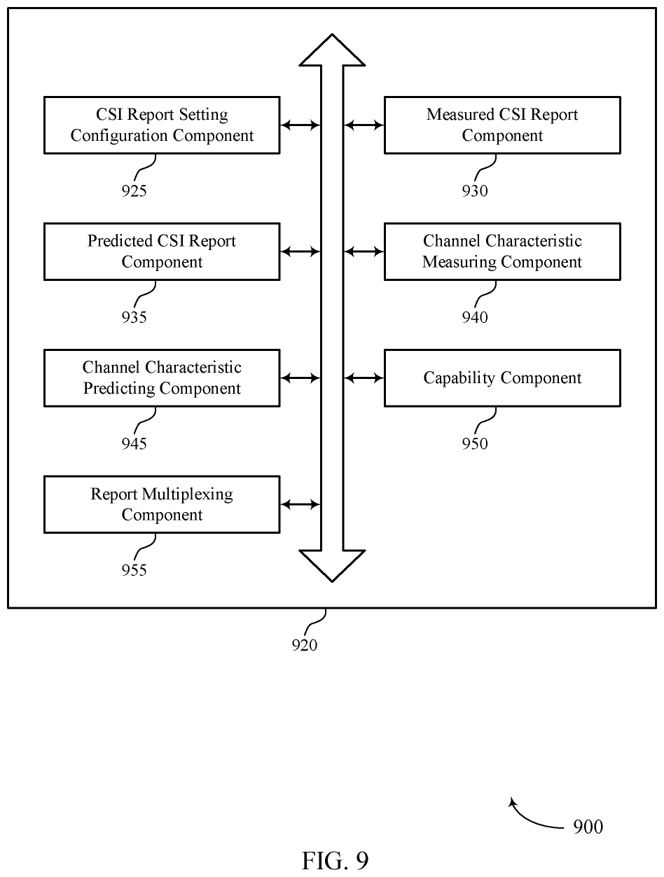

FIG. 9 shows a block diagram 900 of a communications manager 920 that supports techniques for separate CSI reporting configurations in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for separate CSI reporting configurations as described herein. For example, the communications manager 920 may include a CSI report setting configuration component 925, a measured CSI report component 930, a predicted CSI report component 935, a channel characteristic measuring component 940, a channel characteristic predicting component 945, a capability component 950, a report multiplexing component 955, or any combination thereof. Each of these components may communicate, directly or indirectly, with one another (e.g., via one or more buses).

The communications manager 920 may support wireless communications at a UE in accordance with examples as disclosed herein. The CSI report setting configuration component 925 may be configured as or otherwise support a means for receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The measured CSI report component 930 may be configured as or otherwise support a means for transmitting a first CSI report that indicates one or more measured channel characteristics of the first CMR set based on the first CSI report setting configuration. The predicted CSI report component 935 may be configured as or otherwise support a means for transmitting a second CSI report that indicates one or more predicted channel characteristics based on the second CSI report setting configuration.

In some examples, to support receiving the control signaling, the CSI report setting configuration component 925 may be configured as or otherwise support a means for receiving the control signaling indicating a periodicity or semi-persistent scheduling associated with the first CMR set, where the second CMR set associated with the first CMR set corresponds to one or more resources occurring a defined time duration after a resource of the first CMR set indicated by the periodicity or the semi-persistent scheduling.

In some examples, to support receiving the control signaling, the CSI report setting configuration component 925 may be configured as or otherwise support a means for receiving the control signaling indicating a first number of resources to report from the first CMR set in the first CSI report, a second number of resources to report from the second CMR set in the second CSI report, or both.

In some examples, the channel characteristic measuring component 940 may be configured as or otherwise support a means for measuring a set of reference signals over the first CMR set at a first time to obtain the one or more measured channel characteristics, where the first CMR set is associated with the first CSI report setting configuration. In some examples, the channel characteristic predicting component 945 may be configured as or otherwise support a means for determining a first set of predicted channel characteristics for the second CMR set for a second time which is later than the first time, where the second CSI report includes the first set of predicted channel characteristics, and the second CMR set is associated with the second CSI report setting configuration.

In some examples, the channel characteristic predicting component 945 may be configured as or otherwise support a means for determining a second set of predicted channel characteristics for a third CMR set for a third time which is later than the first time and the second time, where the third CMR set is associated with the second CMR set and the second CSI report setting configuration. In some examples, the predicted CSI report component 935 may be configured as or otherwise support a means for transmitting a third CSI report indicating the second set of predicted channel characteristics based on the second CSI report setting configuration.

In some examples, to support receiving the control signaling, the CSI report setting configuration component 925 may be configured as or otherwise support a means for receiving the control signaling indicating a first set of beams for reporting the measured channel characteristics associated with the first CMR set and the second CMR set, where the control signaling indicates to report the one or more predicted channel characteristics for a second set of beams associated with highest predicted channel characteristics of the second CMR set.

In some examples, to support receiving the control signaling, the CSI report setting configuration component 925 may be configured as or otherwise support a means for receiving the control signaling indicating a first number of beams to report in the first CSI report, a second number of beams to report in the second CSI report, or both.

In some examples, the channel characteristic measuring component 940 may be configured as or otherwise support a means for measuring a set of reference signals over a first set of spatial beams of the first CMR set to obtain the one or more measured channel characteristics. In some examples, the channel characteristic predicting component 945 may be configured as or otherwise support a means for determining the one or more predicted channel characteristics for a second set of spatial beams of the second CMR set, where the first CMR set and the second CMR set are a same CMR set.

In some examples, the CSI report setting configuration component 925 may be configured as or otherwise support a means for receiving, from the network entity, an indication of the first set of spatial beams of the first CMR set, where the set of reference signals are measured over the first set of spatial beams based on the indication.

In some examples, the channel characteristic measuring component 940 may be configured as or otherwise support a means for determining, by the UE, the first set of spatial beams, where the set of reference signals are measured over the first set of spatial beams based on the determining.

In some examples, to support receiving the control signaling, the CSI report setting configuration component 925 may be configured as or otherwise support a means for receiving the control signaling indicating a first radio frequency spectrum band associated with the first CMR set, where the second CMR set associated with the first CMR set corresponds to a second radio frequency spectrum band associated with the first radio frequency spectrum band.

In some examples, the channel characteristic measuring component 940 may be configured as or otherwise support a means for measuring a set of reference signals over a first radio frequency spectrum band including the first CMR set to obtain the one or more measured channel characteristics, where the first CMR set is associated with the first CSI report setting configuration. In some examples, the channel characteristic predicting component 945 may be configured as or otherwise support a means for determining the one or more predicted channel characteristics for a second radio frequency spectrum band including the second CMR set, where the second CMR set is associated with the second CSI report setting configuration.

In some examples, the first radio frequency spectrum band and the second radio frequency spectrum band correspond to different bandwidth parts, different frequency ranges, different serving cells, or any combination thereof.

In some examples, the capability component 950 may be configured as or otherwise support a means for transmitting, to the network entity, an indication of a UE capability to support multiple CSI report setting configurations, where the control signaling indicating the first CSI report setting configuration and the second CSI report setting configuration is received in response to the indication of the UE capability.

In some examples, the indication of the UE capability includes a first number of supported configurations for the first CSI report setting configuration, a second number of supported configurations for the second CSI report setting configuration, a maximum number of supported configurations for both the first CSI report setting configuration and the second CSI report setting configuration, a number of processors supported for the first CSI report setting configuration or the second CSI report setting configuration, or both, or any combination thereof.

In some examples, to support transmitting the second CSI report, the report multiplexing component 955 may be configured as or otherwise support a means for transmitting the second CSI report on a same uplink channel as the first CSI report, where the first CSI report and the second CSI report are multiplexed on the same uplink channel.

In some examples, the report multiplexing component 955 may be configured as or otherwise support a means for determining a third CSI report associated with the first CSI report setting configuration is scheduled to at least partially overlap on an uplink channel with a fourth CSI report associated with the second CSI report setting configuration. In some examples, the report multiplexing component 955 may be configured as or otherwise support a means for dropping the third CSI report based on predicted channel characteristics having a higher priority than measured channel characteristics. In some examples, the report multiplexing component 955 may be configured as or otherwise support a means for transmitting (e.g., via a transceiver) the fourth CSI report on the uplink channel based on the second CSI report setting configuration.

In some examples, the report multiplexing component 955 may be configured as or otherwise support a means for determining a third CSI report associated with the first CSI report setting configuration is scheduled to at least partially overlap on an uplink channel with a fourth CSI report associated with the second CSI report setting configuration. In some examples, the report multiplexing component 955 may be configured as or otherwise support a means for dropping the fourth CSI report based on measured channel characteristics having a higher priority than predicted channel characteristics. In some examples, the report multiplexing component 955 may be configured as or otherwise support a means for transmitting (e.g., via a transceiver) the third CSI report on the uplink channel based on the first CSI report setting configuration.

In some examples, the first CSI report includes a first number of measured channel characteristics that is equal to a second number of predicted channel characteristics in the second CSI report.

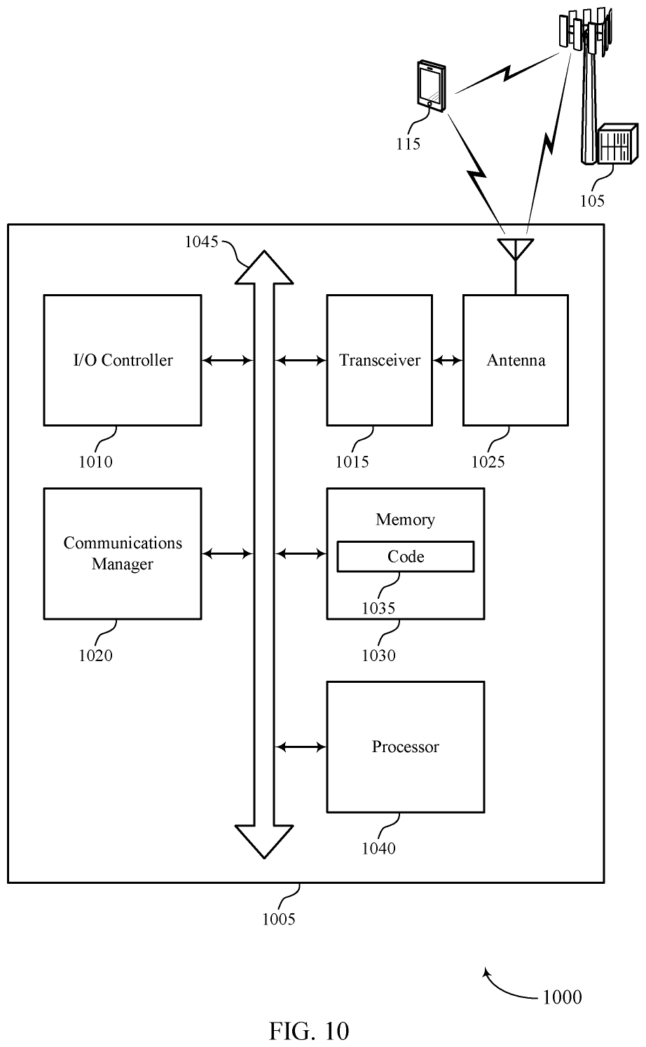

FIG. 10 shows a diagram of a system 1000 including a device 1005 that supports techniques for separate CSI reporting configurations in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for separate CSI reporting configurations). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The communications manager 1020 may be configured as or otherwise support a means for transmitting a first CSI report that indicates one or more measured channel characteristics of the first CMR set based on the first CSI report setting configuration. The communications manager 1020 may be configured as or otherwise support a means for transmitting a second CSI report that indicates one or more predicted channel characteristics based on the second CSI report setting configuration.

By including or configuring the communications manager 1020 in accordance with examples as described herein, the device 1005 may support techniques for lower overhead while supporting CSI reports for both measured and predicted channel characteristics. For example, by using separate CSI report settings for measured and predicted channel characteristics, a CSI report may include fields related to either measured channel characteristics or predicted channel characteristics instead of including unused fields.

In some examples, the communications manager 1020 may be configured to perform various operations (e.g., receiving, monitoring, transmitting) using or otherwise in cooperation with the transceiver 1015, the one or more antennas 1025, or any combination thereof. For example, the communications manager 1020 may be configured to receive or transmit messages or other signaling as described herein via the transceiver 1015. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for separate CSI reporting configurations as described herein, or the processor 1040 and the memory 1030 may be otherwise configured to perform or support such operations.

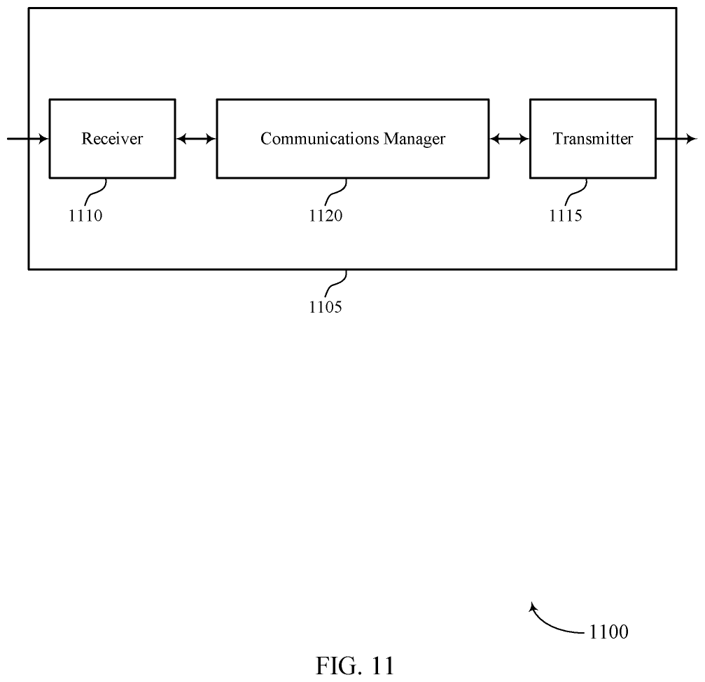

FIG. 11 shows a block diagram 1100 of a device 1105 that supports techniques for separate CSI reporting configurations in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for separate CSI reporting configurations as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting control signaling indicating a first CSI report setting configuration associated with measured channel characteristics of a first CMR set and a second CSI report setting configuration associated with predicted channel characteristics for a second CMR set that is associated with the first CMR set. The communications manager 1120 may be configured as or otherwise support a means for receiving a first CSI report that indicates one or more measured channel characteristics of the first CMR set based on the first CSI report setting configuration. The communications manager 1120 may be configured as or otherwise support a means for receiving a second CSI report that indicates one or more predicted channel characteristics of the second CMR set based on the second CSI report setting configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communications resources due to lower overhead for CSI reporting. For example, by using separate CSI report settings for measured and predicted channel characteristics, a CSI report may include fields related to either measured channel characteristics or predicted channel characteristics instead of including unused fields, which may reduce overall payload size.

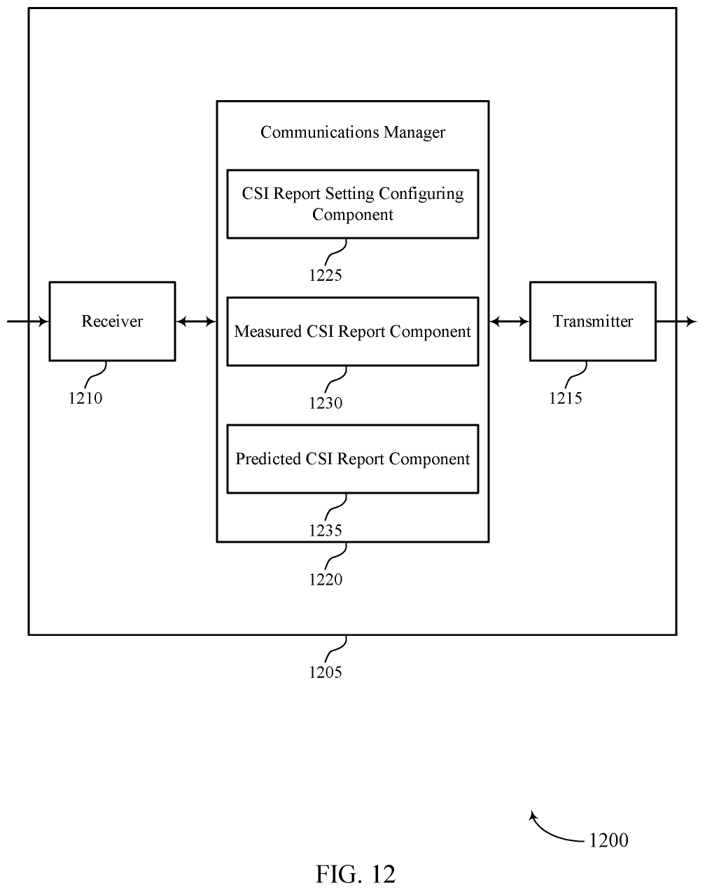

FIG. 12 shows a block diagram 1200 of a device 1205 that supports techniques for separate CSI reporting configurations in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for separate CSI reporting configurations as described herein. For example, the communications manager 1220 may include a CSI report setting configuring component 1225, a measured CSI report component 1230, a predicted CSI report component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The CSI report setting configuring component 1225 may be configured as or otherwise support a means for transmitting control signaling indicating a first CSI report setting configuration associated with measured channel characteristics of a first CMR set and a second CSI report setting configuration associated with predicted channel characteristics for a second CMR set that is associated with the first CMR set. The measured CSI report component 1230 may be configured as or otherwise support a means for receiving a first CSI report that indicates one or more measured channel characteristics of the first CMR set based on the first CSI report setting configuration. The predicted CSI report component 1235 may be configured as or otherwise support a means for receiving a second CSI report that indicates one or more predicted channel characteristics of the second CMR set based on the second CSI report setting configuration.

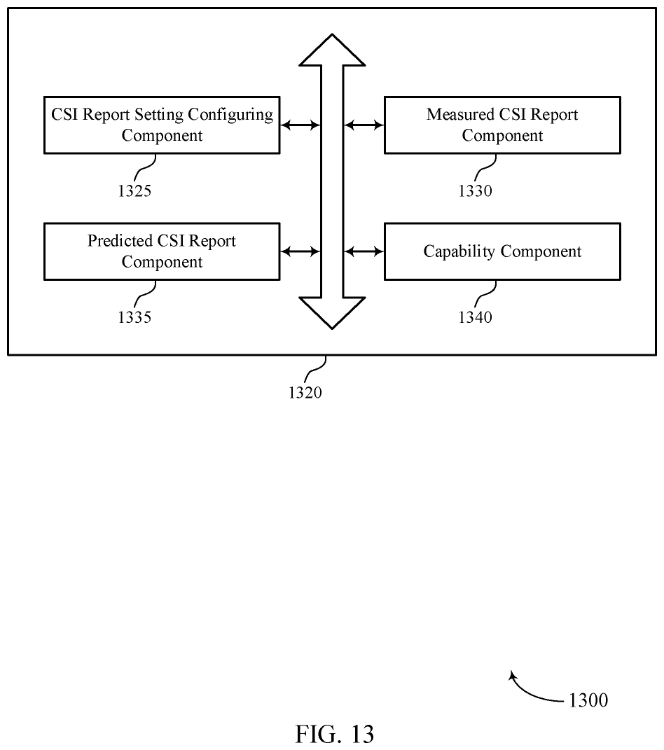

FIG. 13 shows a block diagram 1300 of a communications manager 1320 that supports techniques for separate CSI reporting configurations in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for separate CSI reporting configurations as described herein. For example, the communications manager 1320 may include a CSI report setting configuring component 1325, a measured CSI report component 1330, a predicted CSI report component 1335, a capability component 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The CSI report setting configuring component 1325 may be configured as or otherwise support a means for transmitting control signaling indicating a first CSI report setting configuration associated with measured channel characteristics of a first CMR set and a second CSI report setting configuration associated with predicted channel characteristics for a second CMR set that is associated with the first CMR set. The measured CSI report component 1330 may be configured as or otherwise support a means for receiving a first CSI report that indicates one or more measured channel characteristics of the first CMR set based on the first CSI report setting configuration. The predicted CSI report component 1335 may be configured as or otherwise support a means for receiving a second CSI report that indicates one or more predicted channel characteristics of the second CMR set based on the second CSI report setting configuration.

In some examples, to support transmitting the control signaling, the CSI report setting configuring component 1325 may be configured as or otherwise support a means for transmitting the control signaling indicating a periodicity or semi-persistent scheduling associated with the first CMR set, where the second CMR set associated with the first CMR set corresponds to one or more resources occurring a defined time duration after a resource of the first CMR set indicated by the periodicity or the semi-persistent scheduling.

In some examples, to support transmitting the control signaling, the CSI report setting configuring component 1325 may be configured as or otherwise support a means for transmitting the control signaling indicating a first number of resources to report from the first CMR set in the first CSI report, a second number of resources to report from the second CMR set in the second CSI report, or both.

In some examples, to support receiving, the measured CSI report component 1330 may be configured as or otherwise support a means for receiving the first CSI report indicating the one or more measured channel characteristics for the first CMR set at a first time, where the first CMR set is associated with the first CSI report setting configuration. In some examples, to support receiving, the predicted CSI report component 1335 may be configured as or otherwise support a means for receiving the second CSI report indicating a first set of predicted channel characteristics for the second CMR set for a second time which is later than the first time, where the second CMR set is associated with the second CSI report setting configuration.

In some examples, to support transmitting the control signaling, the CSI report setting configuring component 1325 may be configured as or otherwise support a means for transmitting the control signaling indicating a first set of beams for reporting the measured channel characteristics associated with the first CMR set and the second CMR set, where the control signaling indicates to report the one or more predicted channel characteristics for a second set of beams associated with highest predicted channel characteristics of the second CMR set.

In some examples, to support receiving, the measured CSI report component 1330 may be configured as or otherwise support a means for receiving the first CSI report indicating the one or more measured channel characteristics for a first set of spatial beams of the first CMR. In some examples, to support receiving, the predicted CSI report component 1335 may be configured as or otherwise support a means for receiving the second CSI report indicating the one or more predicted channel characteristics for a second set of spatial beams of the second CMR set.

In some examples, to support transmitting the control signaling, the CSI report setting configuring component 1325 may be configured as or otherwise support a means for transmitting the control signaling indicating a first radio frequency spectrum band associated with the first CMR set, where the second CMR set associated with the first CMR set corresponds to a second radio frequency spectrum band associated with the first radio frequency spectrum band.

In some examples, to support receiving, the measured CSI report component 1330 may be configured as or otherwise support a means for receiving the first CSI report indicating the one or more measured channel characteristics for a first radio frequency spectrum band including the first CMR set, where the first CMR set is associated with the first CSI report setting configuration. In some examples, to support receiving, the predicted CSI report component 1335 may be configured as or otherwise support a means for receiving the second CSI report indicating the one or more predicted channel characteristics for a second radio frequency spectrum band including the second CMR set, where the second CMR set is associated with the second CSI report setting configuration.

In some examples, the capability component 1340 may be configured as or otherwise support a means for receiving an indication of a UE capability to support multiple CSI report setting configuration, where the control signaling indicating the first CSI report setting configuration and the second CSI report setting configuration is transmitted in response to the indication of the UE capability.

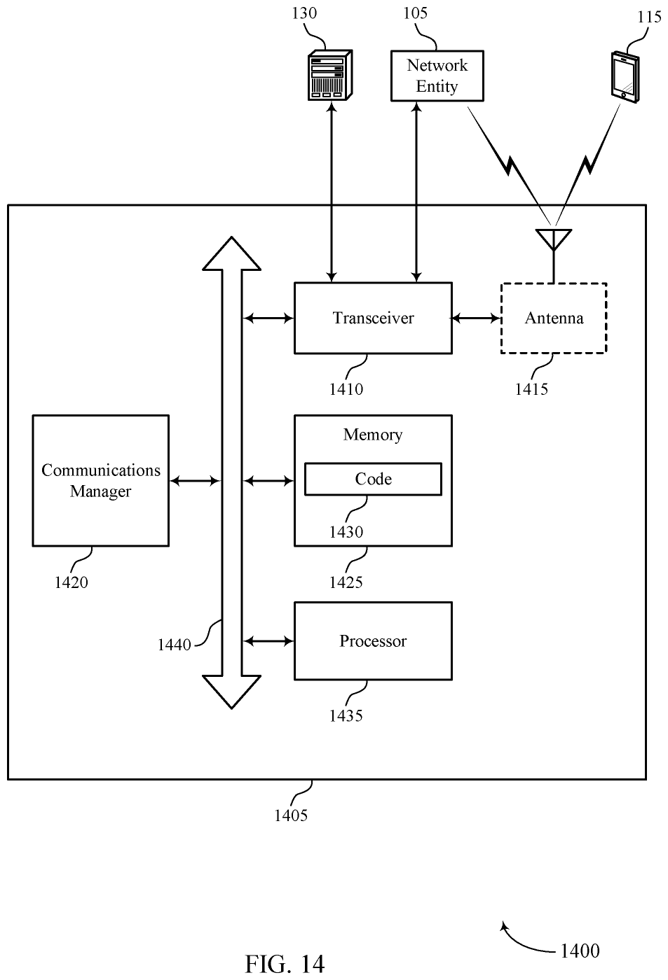

FIG. 14 shows a diagram of a system 1400 including a device 1405 that supports techniques for separate CSI reporting configurations in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for separate CSI reporting configurations). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting control signaling indicating a first CSI report setting configuration associated with measured channel characteristics of a first CMR set and a second CSI report setting configuration associated with predicted channel characteristics for a second CMR set that is associated with the first CMR set. The communications manager 1420 may be configured as or otherwise support a means for receiving a first CSI report that indicates one or more measured channel characteristics of the first CMR set based on the first CSI report setting configuration. The communications manager 1420 may be configured as or otherwise support a means for receiving a second CSI report that indicates one or more predicted channel characteristics of the second CMR set based on the second CSI report setting configuration.

By including or configuring the communications manager 1420 in accordance with examples as described herein, the device 1405 may support techniques for lower overhead while supporting CSI reports for both measured and predicted channel characteristics. For example, by using separate CSI report settings for measured and predicted channel characteristics, a CSI report may include fields related to either measured channel characteristics or predicted channel characteristics instead of including unused fields.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. For example, the communications manager 1420 may be configured to receive or transmit messages or other signaling as described herein via the transceiver 1410. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of techniques for separate CSI reporting configurations as described herein, or the processor 1435 and the memory 1425 may be otherwise configured to perform or support such operations.

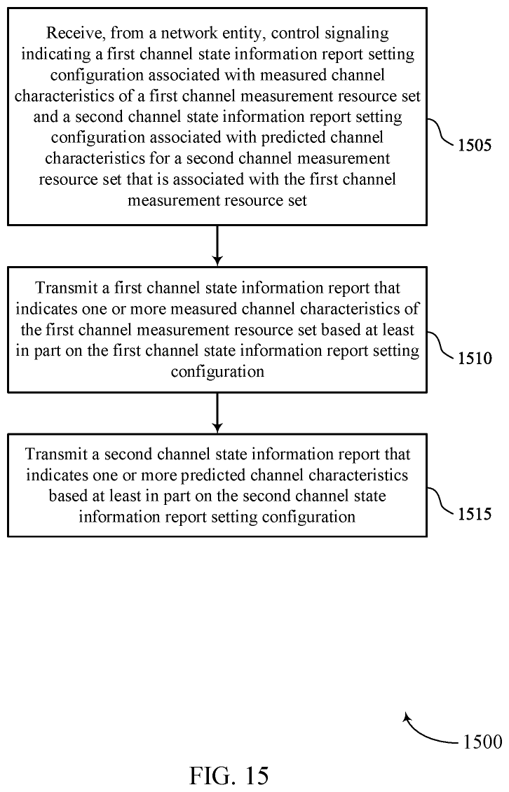

FIG. 15 shows a flowchart illustrating a method 1500 that supports techniques for separate CSI reporting configurations in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The operations of 1505 may be performed in accordance with examples as disclosed herein. In some examples, aspects of the operations of 1505 may be performed by a CSI report setting configuration component 925 as described with reference to FIG. 9.

At 1510, the method may include transmitting a first CSI report that indicates one or more measured channel characteristics of the first CMR set based on the first CSI report setting configuration. The operations of 1510 may be performed in accordance with examples as disclosed herein. In some examples, aspects of the operations of 1510 may be performed by a measured CSI report component 930 as described with reference to FIG. 9.

At 1515, the method may include transmitting a second CSI report that indicates one or more predicted channel characteristics based on the second CSI report setting configuration. The operations of 1515 may be performed in accordance with examples as disclosed herein. In some examples, aspects of the operations of 1515 may be performed by a predicted CSI report component 935 as described with reference to FIG. 9.

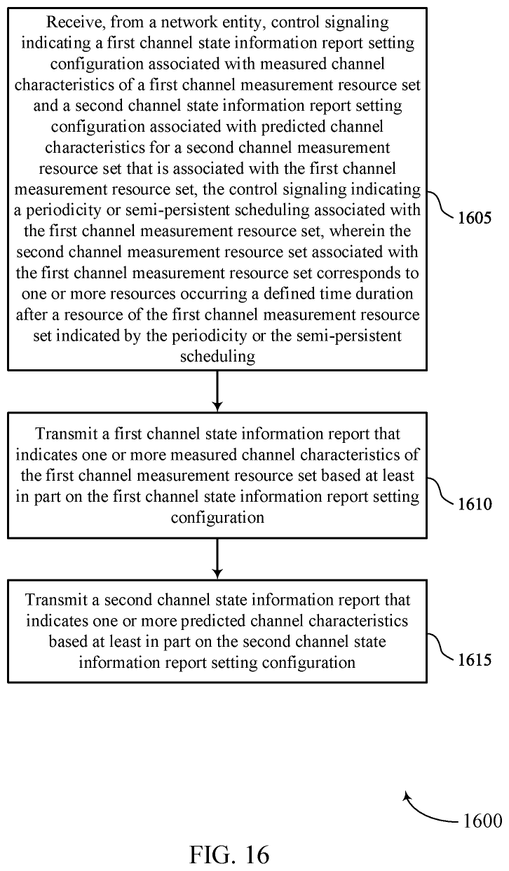

FIG. 16 shows a flowchart illustrating a method 1600 that supports techniques for separate CSI reporting configurations in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling indicating a first CSI report setting configuration associated with measured channel characteristics of a first CMR set and a second CSI report setting configuration associated with predicted channel characteristics for a second CMR set that is associated with the first CMR set. The control signaling may indicate a periodicity or semi-persistent scheduling associated with the first CMR set, where the second CMR set associated with the first CMR set corresponds to one or more resources occurring a defined time duration after a resource of the first CMR set indicated by the periodicity or the semi-persistent scheduling The operations of 1605 may be performed in accordance with examples as disclosed herein. In some examples, aspects of the operations of 1605 may be performed by a CSI report setting configuration component 925 as described with reference to FIG. 9.

At 1610, the method may include transmitting a first CSI report that indicates one or more measured channel characteristics of the first CMR set based on the first CSI report setting configuration. The operations of 1610 may be performed in accordance with examples as disclosed herein. In some examples, aspects of the operations of 1610 may be performed by a measured CSI report component 930 as described with reference to FIG. 9.

At 1615, the method may include transmitting a second CSI report that indicates one or more predicted channel characteristics based on the second CSI report setting configuration. The operations of 1615 may be performed in accordance with examples as disclosed herein. In some examples, aspects of the operations of 1615 may be performed by a predicted CSI report component 935 as described with reference to FIG. 9.

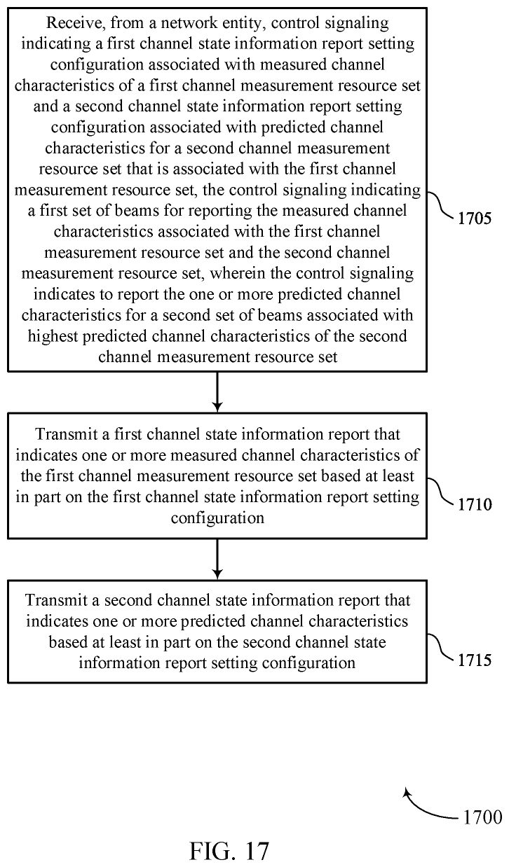

FIG. 17 shows a flowchart illustrating a method 1700 that supports techniques for separate CSI reporting configurations in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling indicating a first CSI report setting configuration associated with measured channel characteristics of a first CMR set and a second CSI report setting configuration associated with predicted channel characteristics for a second CMR set that is associated with the first CMR set. In some cases, the control signaling may indicate a first set of beams for reporting the measured channel characteristics associated with the first CMR set and the second CMR set, where the control signaling indicates to report the one or more predicted channel characteristics for a second set of beams associated with highest predicted channel characteristics of the second CMR set The operations of 1705 may be performed in accordance with examples as disclosed herein. In some examples, aspects of the operations of 1705 may be performed by a CSI report setting configuration component 925 as described with reference to FIG. 9.

At 1710, the method may include transmitting a first CSI report that indicates one or more measured channel characteristics of the first CMR set based on the first CSI report setting configuration. The operations of 1710 may be performed in accordance with examples as disclosed herein. In some examples, aspects of the operations of 1710 may be performed by a measured CSI report component 930 as described with reference to FIG. 9.

At 1715, the method may include transmitting a second CSI report that indicates one or more predicted channel characteristics based on the second CSI report setting configuration. The operations of 1715 may be performed in accordance with examples as disclosed herein. In some examples, aspects of the operations of 1715 may be performed by a predicted CSI report component 935 as described with reference to FIG. 9.

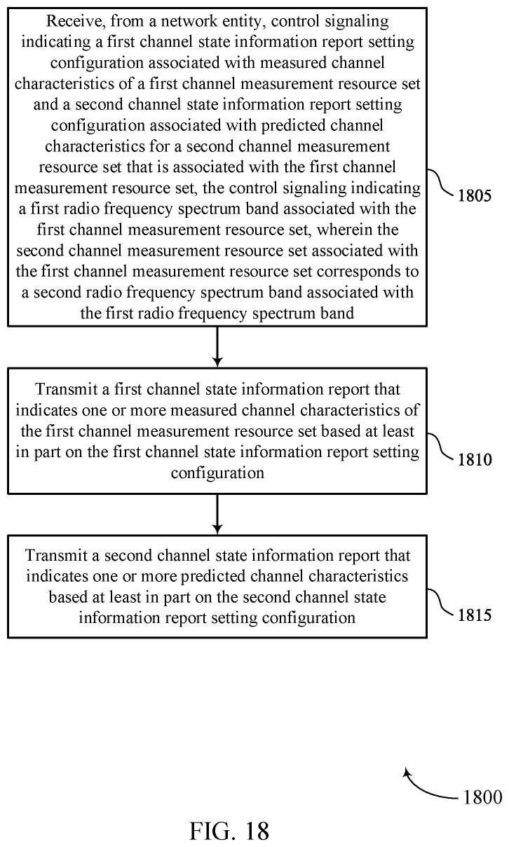

FIG. 18 shows a flowchart illustrating a method 1800 that supports techniques for separate CSI reporting configurations in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, control signaling indicating a first CSI report setting configuration associated with measured channel characteristics of a first CMR set and a second CSI report setting configuration associated with predicted channel characteristics for a second CMR set that is associated with the first CMR set. In some cases, the control signaling may indicate a first radio frequency spectrum band associated with the first CMR set, where the second CMR set associated with the first CMR set corresponds to a second radio frequency spectrum band associated with the first radio frequency spectrum band The operations of 1805 may be performed in accordance with examples as disclosed herein. In some examples, aspects of the operations of 1805 may be performed by a CSI report setting configuration component 925 as described with reference to FIG. 9.

At 1810, the method may include transmitting a first CSI report that indicates one or more measured channel characteristics of the first CMR set based on the first CSI report setting configuration. The operations of 1810 may be performed in accordance with examples as disclosed herein. In some examples, aspects of the operations of 1810 may be performed by a measured CSI report component 930 as described with reference to FIG. 9.

At 1815, the method may include transmitting a second CSI report that indicates one or more predicted channel characteristics based on the second CSI report setting configuration. The operations of 1815 may be performed in accordance with examples as disclosed herein. In some examples, aspects of the operations of 1815 may be performed by a predicted CSI report component 935 as described with reference to FIG. 9.

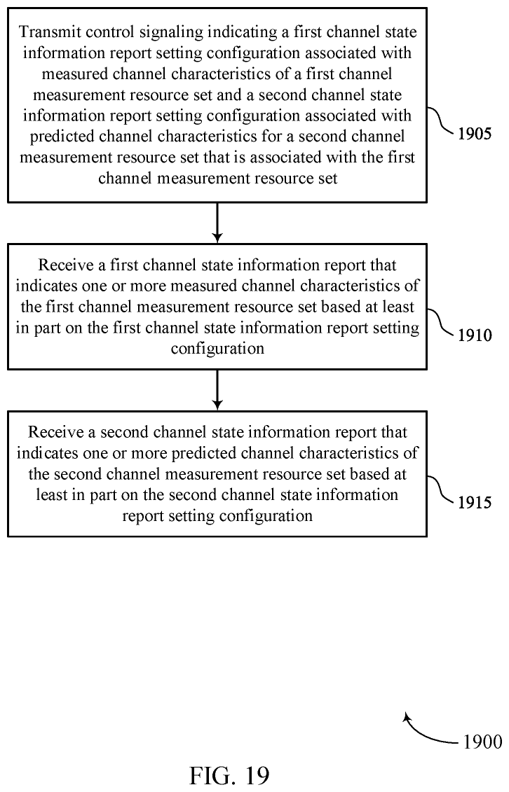

FIG. 19 shows a flowchart illustrating a method 1900 that supports techniques for separate CSI reporting configurations in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting control signaling indicating a first CSI report setting configuration associated with measured channel characteristics of a first CMR set and a second CSI report setting configuration associated with predicted channel characteristics for a second CMR set that is associated with the first CMR set. The operations of 1905 may be performed in accordance with examples as disclosed herein. In some examples, aspects of the operations of 1905 may be performed by a CSI report setting configuring component 1325 as described with reference to FIG. 13.

At 1910, the method may include receiving a first CSI report that indicates one or more measured channel characteristics of the first CMR set based on the first CSI report setting configuration. The operations of 1910 may be performed in accordance with examples as disclosed herein. In some examples, aspects of the operations of 1910 may be performed by a measured CSI report component 1330 as described with reference to FIG. 13.

At 1915, the method may include receiving a second CSI report that indicates one or more predicted channel characteristics of the second CMR set based on the second CSI report setting configuration. The operations of 1915 may be performed in accordance with examples as disclosed herein. In some examples, aspects of the operations of 1915 may be performed by a predicted CSI report component 1335 as described with reference to FIG. 13.

The following provides an overview of aspects of the present disclosure:

Aspect 1: A method for wireless communications at a UE, comprising: receiving, from a network entity, control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set; transmitting a first channel state information report that indicates one or more measured channel characteristics of the first channel measurement resource set based at least in part on the first channel state information report setting configuration; and transmitting a second channel state information report that indicates one or more predicted channel characteristics based at least in part on the second channel state information report setting configuration.

Aspect 2: The method of aspect 1, wherein receiving the control signaling comprises: receiving the control signaling indicating a periodicity or semi-persistent scheduling associated with the first channel measurement resource set, wherein the second channel measurement resource set associated with the first channel measurement resource set corresponds to one or more resources occurring a defined time duration after a resource of the first channel measurement resource set indicated by the periodicity or the semi-persistent scheduling.

Aspect 3: The method of aspect 2, wherein receiving the control signaling comprises: receiving the control signaling indicating a first number of resources to report from the first channel measurement resource set in the first channel state information report, a second number of resources to report from the second channel measurement resource set in the second channel state information report, or both.

Aspect 4: The method of any of aspects 1 through 3, further comprising: measuring a set of reference signals over the first channel measurement resource set at a first time to obtain the one or more measured channel characteristics, wherein the first channel measurement resource set is associated with the first channel state information report setting configuration; and determining a first set of predicted channel characteristics for the second channel measurement resource set for a second time which is later than the first time, wherein the second channel state information report includes the first set of predicted channel characteristics, and the second channel measurement resource set is associated with the second channel state information report setting configuration.

Aspect 5: The method of aspect 4, further comprising: determining a second set of predicted channel characteristics for a third channel measurement resource set for a third time which is later than the first time and the second time, wherein the third channel measurement resource set is associated with the second channel measurement resource set and the second channel state information report setting configuration; and transmitting a third channel state information report indicating the second set of predicted channel characteristics based at least in part on the second channel state information report setting configuration.

Aspect 6: The method of any of aspects 1 through 5, wherein receiving the control signaling comprises: receiving the control signaling indicating a first set of beams for reporting the measured channel characteristics associated with the first channel measurement resource set and the second channel measurement resource set, wherein the control signaling indicates to report the one or more predicted channel characteristics for a second set of beams associated with highest predicted channel characteristics of the second channel measurement resource set.

Aspect 7: The method of aspect 6, wherein receiving the control signaling comprises: receiving the control signaling indicating a first number of beams to report in the first channel state information report, a second number of beams to report in the second channel state information report, or both.

Aspect 8: The method of any of aspects 1 through 7, further comprising: measuring a set of reference signals over a first set of spatial beams of the first channel measurement resource set to obtain the one or more measured channel characteristics; and determining the one or more predicted channel characteristics for a second set of spatial beams of the second channel measurement resource set, wherein the first channel measurement resource set and the second channel measurement resource set are a same channel measurement resource set.

Aspect 9: The method of aspect 8, further comprising: receiving, from the network entity, an indication of the first set of spatial beams of the first channel measurement resource set, wherein the set of reference signals are measured over the first set of spatial beams based at least in part on the indication.

Aspect 10: The method of any of aspects 8 through 9, further comprising: determining, by the UE, the first set of spatial beams, wherein the set of reference signals are measured over the first set of spatial beams based at least in part on the determining.

Aspect 11: The method of any of aspects 1 through 10, wherein receiving the control signaling comprises: receiving the control signaling indicating a first radio frequency spectrum band associated with the first channel measurement resource set, wherein the second channel measurement resource set associated with the first channel measurement resource set corresponds to a second radio frequency spectrum band associated with the first radio frequency spectrum band.

Aspect 12: The method of any of aspects 1 through 11, further comprising: measuring a set of reference signals over a first radio frequency spectrum band comprising the first channel measurement resource set to obtain the one or more measured channel characteristics, wherein the first channel measurement resource set is associated with the first channel state information report setting configuration; and determining the one or more predicted channel characteristics for a second radio frequency spectrum band comprising the second channel measurement resource set, wherein the second channel measurement resource set is associated with the second channel state information report setting configuration.

Aspect 13: The method of aspect 12, wherein the first radio frequency spectrum band and the second radio frequency spectrum band correspond to different bandwidth parts, different frequency ranges, different serving cells, or any combination thereof.

Aspect 14: The method of any of aspects 1 through 13, further comprising: transmitting, to the network entity, an indication of a UE capability to support multiple channel state information report setting configurations, wherein the control signaling indicating the first channel state information report setting configuration and the second channel state information report setting configuration is received in response to the indication of the UE capability.

Aspect 15: The method of aspect 14, wherein the indication of the UE capability includes a first number of supported configurations for the first channel state information report setting configuration, a second number of supported configurations for the second channel state information report setting configuration, a maximum number of supported configurations for both the first channel state information report setting configuration and the second channel state information report setting configuration, a number of processors supported for the first channel state information report setting configuration or the second channel state information report setting configuration, or both, or any combination thereof.

Aspect 16: The method of any of aspects 1 through 15, wherein transmitting the second channel state information report comprises: transmitting the second channel state information report on a same uplink channel as the first channel state information report, wherein the first channel state information report and the second channel state information report are multiplexed on the same uplink channel.

Aspect 17: The method of any of aspects 1 through 16, further comprising: determining a third channel state information report associated with the first channel state information report setting configuration is scheduled to at least partially overlap on an uplink channel with a fourth channel state information report associated with the second channel state information report setting configuration; dropping the third channel state information report based at least in part on predicted channel characteristics having a higher priority than measured channel characteristics; and transmitting the fourth channel state information report on the uplink channel based at least in part on the second channel state information report setting configuration.

Aspect 18: The method of any of aspects 1 through 17, further comprising: determining a third channel state information report associated with the first channel state information report setting configuration is scheduled to at least partially overlap on an uplink channel with a fourth channel state information report associated with the second channel state information report setting configuration; dropping the fourth channel state information report based at least in part on measured channel characteristics having a higher priority than predicted channel characteristics; and transmitting the third channel state information report on the uplink channel based at least in part on the first channel state information report setting configuration.

Aspect 19: The method of any of aspects 1 through 18, wherein the first channel state information report includes a first number of measured channel characteristics that is equal to a second number of predicted channel characteristics in the second channel state information report.

Aspect 20: A method for wireless communications at a network entity, comprising: transmitting control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set; receiving a first channel state information report that indicates one or more measured channel characteristics of the first channel measurement resource set based at least in part on the first channel state information report setting configuration; and receiving a second channel state information report that indicates one or more predicted channel characteristics of the second channel measurement resource set based at least in part on the second channel state information report setting configuration.

Aspect 21: The method of aspect 20, wherein transmitting the control signaling comprises: transmitting the control signaling indicating a periodicity or semi-persistent scheduling associated with the first channel measurement resource set, wherein the second channel measurement resource set associated with the first channel measurement resource set corresponds to one or more resources occurring a defined time duration after a resource of the first channel measurement resource set indicated by the periodicity or the semi-persistent scheduling.

Aspect 22: The method of aspect 21, wherein transmitting the control signaling comprises: transmitting the control signaling indicating a first number of resources to report from the first channel measurement resource set in the first channel state information report, a second number of resources to report from the second channel measurement resource set in the second channel state information report, or both.

Aspect 23: The method of any of aspects 20 through 22, wherein the receiving comprises: receiving the first channel state information report indicating the one or more measured channel characteristics for the first channel measurement resource set at a first time, wherein the first channel measurement resource set is associated with the first channel state information report setting configuration; and receiving the second channel state information report indicating a first set of predicted channel characteristics for the second channel measurement resource set for a second time which is later than the first time, wherein the second channel measurement resource set is associated with the second channel state information report setting configuration.

Aspect 24: The method of any of aspects 20 through 23, wherein transmitting the control signaling comprises: transmitting the control signaling indicating a first set of beams for reporting the measured channel characteristics associated with the first channel measurement resource set and the second channel measurement resource set, wherein the control signaling indicates to report the one or more predicted channel characteristics for a second set of beams associated with highest predicted channel characteristics of the second channel measurement resource set.

Aspect 25: The method of any of aspects 20 through 24, wherein the receiving comprises: receiving the first channel state information report indicating the one or more measured channel characteristics for a first set of spatial beams of the first channel measurement resource; and receiving the second channel state information report indicating the one or more predicted channel characteristics for a second set of spatial beams of the second channel measurement resource set.

Aspect 26: The method of any of aspects 20 through 25, wherein transmitting the control signaling comprises: transmitting the control signaling indicating a first radio frequency spectrum band associated with the first channel measurement resource set, wherein the second channel measurement resource set associated with the first channel measurement resource set corresponds to a second radio frequency spectrum band associated with the first radio frequency spectrum band.

Aspect 27: The method of any of aspects 20 through 26, wherein the receiving comprises: receiving the first channel state information report indicating the one or more measured channel characteristics for a first radio frequency spectrum band comprising the first channel measurement resource set, wherein the first channel measurement resource set is associated with the first channel state information report setting configuration; and receiving the second channel state information report indicating the one or more predicted channel characteristics for a second radio frequency spectrum band comprising the second channel measurement resource set, wherein the second channel measurement resource set is associated with the second channel state information report setting configuration.

Aspect 28: The method of any of aspects 20 through 27, further comprising: receiving an indication of a UE capability to support multiple channel state information report setting configuration, wherein the control signaling indicating the first channel state information report setting configuration and the second channel state information report setting configuration is transmitted in response to the indication of the UE capability.

Aspect 29: An apparatus for wireless communications, comprising memory; a transceiver; and at least one processor of a UE, the at least one processor coupled with memory and the transceiver, and the at least one processor configured to cause the apparatus to perform a method of any of aspects 1 through 19.

Aspect 30: An apparatus for wireless communications at a UE, comprising at least one means for performing a method of any of aspects 1 through 19.

Aspect 31: A non-transitory computer-readable medium storing code for wireless communications at a UE, the code comprising instructions executable by a processor to perform a method of any of aspects 1 through 19.

Aspect 32: An apparatus for wireless communications at a network entity, comprising memory; a transceiver; and at least one processor of a network entity, the at least one processor coupled with memory and the transceiver, and the at least one processor configured to cause the apparatus to perform a method of any of aspects 20 through 28.

Aspect 33: An apparatus for wireless communications at a network entity, comprising at least one means for performing a method of any of aspects 20 through 28.

Aspect 34: A non-transitory computer-readable medium storing code for wireless communications at a network entity, the code comprising instructions executable by a processor to perform a method of any of aspects 20 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications, comprising:
memory:
a transceiver; and
at least one processor of a user equipment (UE), the at least one processor coupled with the memory and the transceiver, and the at least one processor configured to cause the apparatus to:
receive, from a network entity via the transceiver, control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set:
transmit, via the transceiver, a first channel state information report that indicates one or more measured channel characteristics of the first channel measurement resource set based at least in part on the first channel state information report setting configuration; and
transmit, via the transceiver, a second channel state information report that indicates one or more predicted channel characteristics based at least in part on the second channel state information report setting configuration.

2. The apparatus of claim 1, wherein to receive the control signaling, the at least one processor is further configured to cause the apparatus to:
receive the control signaling indicating a periodicity or semi-persistent scheduling associated with the first channel measurement resource set, wherein the second channel measurement resource set associated with the first channel measurement resource set corresponds to one or more resources occurring a defined time duration after a resource of the first channel measurement resource set indicated by the periodicity or the semi-persistent scheduling.

3. The apparatus of claim 2, wherein to receive the control signaling, the at least one processor is further configured to cause the apparatus to:
receive the control signaling indicating a first number of resources to report from the first channel measurement resource set in the first channel state information report, a second number of resources to report from the second channel measurement resource set in the second channel state information report, or both.

4. The apparatus of claim 1, the at least one processor further configured to cause the apparatus to:
measure a set of reference signals over the first channel measurement resource set at a first time to obtain the one or more measured channel characteristics, wherein the first channel measurement resource set is associated with the first channel state information report setting configuration; and
determine a first set of predicted channel characteristics for the second channel measurement resource set for a second time which is later than the first time, wherein the second channel state information report includes the first set of predicted channel characteristics, and the second channel measurement resource set is associated with the second channel state information report setting configuration.

5. The apparatus of claim 4, the at least one processor further configured to cause the apparatus to:
determine a second set of predicted channel characteristics for a third channel measurement resource set for a third time which is later than the first time and the second time, wherein the third channel measurement resource set is associated with the second channel measurement resource set and the second channel state information report setting configuration; and
transmit, via the transceiver, a third channel state information report indicating the second set of predicted channel characteristics based at least in part on the second channel state information report setting configuration.

6. The apparatus of claim 1, wherein to receive the control signaling, the at least one processor is further configured to cause the apparatus to:
receive the control signaling indicating a first set of beams for reporting the measured channel characteristics associated with the first channel measurement resource set and the second channel measurement resource set, wherein the control signaling indicates to report the one or more predicted channel characteristics for a second set of beams associated with highest predicted channel characteristics of the second channel measurement resource set.

7. The apparatus of claim 6, wherein to receive the control signaling, the at least one processor is further configured to cause the apparatus to:
receive the control signaling indicating a first number of beams to report in the first channel state information report, a second number of beams to report in the second channel state information report, or both.

8. The apparatus of claim 1, the at least one processor further configured to cause the apparatus to:
measure a set of reference signals over a first set of spatial beams of the first channel measurement resource set to obtain the one or more measured channel characteristics; and
determine the one or more predicted channel characteristics for a second set of spatial beams of the second channel measurement resource set, wherein the first channel measurement resource set and the second channel measurement resource set are a same channel measurement resource set.

9. The apparatus of claim 8, the at least one processor further configured to cause the apparatus to:
receive, from the network entity via the transceiver, an indication of the first set of spatial beams of the first channel measurement resource set, wherein the set of reference signals are measured over the first set of spatial beams based at least in part on the indication.

10. The apparatus of claim 8, the at least one processor further configured to cause the apparatus to:
determine, by the UE, the first set of spatial beams, wherein the set of reference signals are measured over the first set of spatial beams based at least in part on the determining.

11. The apparatus of claim 1, wherein to receive the control signaling, the at least one processor is further configured to cause the apparatus to:
receive the control signaling indicating a first radio frequency spectrum band associated with the first channel measurement resource set, wherein the second channel measurement resource set associated with the first channel measurement resource set corresponds to a second radio frequency spectrum band associated with the first radio frequency spectrum band.

12. The apparatus of claim 1, the at least one processor further configured to cause the apparatus to:
measure a set of reference signals over a first radio frequency spectrum band comprising the first channel measurement resource set to obtain the one or more measured channel characteristics, wherein the first channel measurement resource set is associated with the first channel state information report setting configuration; and
determine the one or more predicted channel characteristics for a second radio frequency spectrum band comprising the second channel measurement resource set, wherein the second channel measurement resource set is associated with the second channel state information report setting configuration.

13. The apparatus of claim 12, wherein the first radio frequency spectrum band and the second radio frequency spectrum band correspond to different bandwidth parts, different frequency ranges, different serving cells, or any combination thereof.

14. The apparatus of claim 1, the at least one processor further configured to cause the apparatus to:
transmit, to the network entity via the transceiver, an indication of a UE capability to support multiple channel state information report setting configurations, wherein the control signaling indicating the first channel state information report setting configuration and the second channel state information report setting configuration is received in response to the indication of the UE capability.

15. The apparatus of claim 14, wherein the indication of the UE capability includes a first number of supported configurations for the first channel state information report setting configuration, a second number of supported configurations for the second channel state information report setting configuration, a maximum number of supported configurations for both the first channel state information report setting configuration and the second channel state information report setting configuration, a number of processors supported for the first channel state information report setting configuration or the second channel state information report setting configuration, or both, or any combination thereof.

16. The apparatus of claim 1, wherein to transmit the second channel state information report, the at least one processor is further configured to cause the apparatus to:
transmit the second channel state information report on a same uplink channel as the first channel state information report, wherein the first channel state information report and the second channel state information report are multiplexed on the same uplink channel.

17. The apparatus of claim 1, the at least one processor further configured to cause the apparatus to:
determine a third channel state information report associated with the first channel state information report setting configuration is scheduled to at least partially overlap on an uplink channel with a fourth channel state information report associated with the second channel state information report setting configuration:
drop the third channel state information report based at least in part on predicted channel characteristics having a higher priority than measured channel characteristics; and
transmit, via the transceiver, the fourth channel state information report on the uplink channel based at least in part on the second channel state information report setting configuration.

18. The apparatus of claim 1, the at least one processor further configured to cause the apparatus to:
determine a third channel state information report associated with the first channel state information report setting configuration is scheduled to at least partially overlap on an uplink channel with a fourth channel state information report associated with the second channel state information report setting configuration:
drop the fourth channel state information report based at least in part on measured channel characteristics having a higher priority than predicted channel characteristics; and
transmit, via the transceiver, the third channel state information report on the uplink channel based at least in part on the first channel state information report setting configuration.

19. The apparatus of claim 1, wherein the first channel state information report includes a first number of measured channel characteristics that is equal to a second number of predicted channel characteristics in the second channel state information report.

20. An apparatus for wireless communications, comprising:
memory; and
at least one processor of a network entity, the at least one processor coupled with the memory, and the at least one processor configured to cause the apparatus to:
transmit control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set:
receive a first channel state information report that indicates one or more measured channel characteristics of the first channel measurement resource set based at least in part on the first channel state information report setting configuration; and
receive a second channel state information report that indicates one or more predicted channel characteristics of the second channel measurement resource set based at least in part on the second channel state information report setting configuration.

21. The apparatus of claim 20, wherein to transmit the control signaling, the at least one processor is further configured to cause the apparatus to:
transmit the control signaling indicating a periodicity or semi-persistent scheduling associated with the first channel measurement resource set, wherein the second channel measurement resource set associated with the first channel measurement resource set corresponds to one or more resources occurring a defined time duration after a resource of the first channel measurement resource set indicated by the periodicity or the semi-persistent scheduling.

22. The apparatus of claim 21, wherein to transmit the control signaling, the at least one processor is further configured to cause the apparatus to:
transmit the control signaling indicating a first number of resources to report from the first channel measurement resource set in the first channel state information report, a second number of resources to report from the second channel measurement resource set in the second channel state information report, or both.

23. The apparatus of claim 20, wherein to receive, the at least one processor is further configured to cause the apparatus to:
receive the first channel state information report indicating the one or more measured channel characteristics for the first channel measurement resource set at a first time, wherein the first channel measurement resource set is associated with the first channel state information report setting configuration; and
receive the second channel state information report indicating a first set of predicted channel characteristics for the second channel measurement resource set for a second time which is later than the first time, wherein the second channel measurement resource set is associated with the second channel state information report setting configuration.

24. The apparatus of claim 20, wherein to transmit the control signaling, the at least one processor is further configured to cause the apparatus to:
transmit the control signaling indicating a first set of beams for reporting the measured channel characteristics associated with the first channel measurement resource set and the second channel measurement resource set, wherein the control signaling indicates to report the one or more predicted channel characteristics for a second set of beams associated with highest predicted channel characteristics of the second channel measurement resource set.

25. The apparatus of claim 20, wherein to receive, the at least one processor is further configured to cause the apparatus to:
receive the first channel state information report indicating the one or more measured channel characteristics for a first set of spatial beams of the first channel measurement resource; and
receive the second channel state information report indicating the one or more predicted channel characteristics for a second set of spatial beams of the second channel measurement resource set.

26. The apparatus of claim 20, wherein to transmit the control signaling, the at least one processor is further configured to cause the apparatus to:
transmit the control signaling indicating a first radio frequency spectrum band associated with the first channel measurement resource set, wherein the second channel measurement resource set associated with the first channel measurement resource set corresponds to a second radio frequency spectrum band associated with the first radio frequency spectrum band.

27. The apparatus of claim 20, wherein to receive, the at least one processor is further configured to cause the apparatus to:
receive the first channel state information report indicating the one or more measured channel characteristics for a first radio frequency spectrum band comprising the first channel measurement resource set, wherein the first channel measurement resource set is associated with the first channel state information report setting configuration; and
receive the second channel state information report indicating the one or more predicted channel characteristics for a second radio frequency spectrum band comprising the second channel measurement resource set, wherein the second channel measurement resource set is associated with the second channel state information report setting configuration.

28. The apparatus of claim 20, the at least one processor is further configured to cause the apparatus to:
receive an indication of a UE capability to support multiple channel state information report setting configuration, wherein the control signaling indicating the first channel state information report setting configuration and the second channel state information report setting configuration is transmitted in response to the indication of the UE capability.

29. A method for wireless communications at a user equipment (UE), comprising:
receiving, from a network entity, control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set:
transmitting a first channel state information report that indicates one or more measured channel characteristics of the first channel measurement resource set based at least in part on the first channel state information report setting configuration; and
transmitting a second channel state information report that indicates one or more predicted channel characteristics based at least in part on the second channel state information report setting configuration.

30. A method for wireless communications at a network entity, comprising:
transmitting control signaling indicating a first channel state information report setting configuration associated with measured channel characteristics of a first channel measurement resource set and a second channel state information report setting configuration associated with predicted channel characteristics for a second channel measurement resource set that is associated with the first channel measurement resource set;
receiving a first channel state information report that indicates one or more measured channel characteristics of the first channel measurement resource set based at least in part on the first channel state information report setting configuration; and
receiving a second channel state information report that indicates one or more predicted channel characteristics of the second channel measurement resource set based at least in part on the second channel state information report setting configuration.
